(19) United States
(12) Patent Application Publication
(10) Pub. No.: US 2026/0098724 A1
(43) Pub. Date: Apr. 9, 2026

(54) METHOD AND APPARATUS FOR ULTRASONIC METAL ADHESIVE BONDLINE THICKNESS TEST

(71) Applicant: Textron Aviation Inc., Wichita, KS (US)

(72) Inventors: Jay Max AMOS, Wichita, KS (US); Sreechand G S, Bengaluru (IN)

(21) Appl. No.: 18/906,485

(22) Filed: Oct. 4, 2024

(51) Int. Cl. G01B 15/02; G06T 11/20

(52) U.S. Cl. CPC G01B 15/02; G06T 11/26; G06T 2200/24

(57) ABSTRACT

The technology of this application relates to an Ultrasonic Test Bondline Thickness system that acquires ultrasonic data using a combination of hardware including a low noise pulser/receiver and high speed wide dynamic range digitizer. A high frequency wideband ultrasonic transducer is used that is small enough to reach difficult areas of interest under stringers and intersection of bonded stiffeners. Iterative pattern recognition signal processing technique(s) using progressive model matching based on reflection coefficients are employed.

### BACKGROUND

The process for building an aircraft has evolved through the years in a manner that allows for greater efficiency and cost effectiveness. A bonding process (e.g., metal bond) exists for building components of the aircraft without having to use additional items (e.g., rivets) to bond the pieces. In one example, a metal layer can be bonded to another metal layer using an adhesive layer. The layers of the structure can include a first metal layer followed by a first adhesive layer, a second metal layer followed by a second adhesive layer, and so on.

The bonding process can be effective at reducing the cost for building an aircraft (or any other type of vehicle). To ensure that the manufacturing process is properly bonding different components of layers of the structure, different techniques exist for testing the bondline thicknesses which is critical to control withing certain limits to maintain bond strength.

Conventional bondline thickness measurement technology, however, is labor intensive and limited in accuracy. For example, conventional thickness gauges (e.g., that employ a Hall effect sensor) can be inaccurate due to wide latitude of precise metal detail thickness allowed by industry tolerance. As another example, Verifilm (e.g. Solvay Cytec FM643) testing can involve labor-intensive tasks plus quality assurance labor to remove layer by layer with high risk of part damage, and physically measure the different representative bondlines. Thus, the conventional techniques leave much room for improvement when it comes to metal adhesive bondline thickness testing.

Accordingly, it will be appreciated that new and improved techniques, systems, and processes are continually sought after.

### BRIEF DESCRIPTION OF THE DRAWINGS

The foregoing and other objects, features and/or advantages will be apparent from the following description of particular embodiments, as illustrated in the accompanying drawings in which like reference characters refer to the same parts throughout the different views. The drawings are not necessarily to scale, emphasis instead being placed upon illustrating the principles of various example embodiments. Each embodiment herein may be used in combination with any other embodiment(s) described herein.

FIG. 1 shows a non-limiting example diagram of a system 1 for testing, among other aspects, bondline thickness;

FIG. 2 shows a non-limiting example block diagram of different components in system 1;

FIG. 3 shows a non-limiting example flowchart for processes associated with system 1;

FIGS. 4A-G show additional non-limiting example flowcharts for processes associated with system 1;

FIGS. 5A-V show non-limiting example diagrams of analysis performed in association with system 1;

FIGS. 6A and 6B show various non-limiting example output generated in association with system 1; and

FIG. 7 shows a non-limiting example block diagram of a hardware architecture.

### DETAILED DESCRIPTION OF EXAMPLE EMBODIMENTS

### Overview

The technology described herein relates to, among other topics, systems and methods for testing metal adhesive bondline thickness. As discussed herein, a bonding process (e.g., metal bond) is widely used in aircraft and other transport structures. Adhesive bondline thickness control is critical to bond strength, so detailed measurements are required for process qualifications. Existing methods available in the industry are costly, inefficient, and limited in accuracy.

The technology described herein relates to an Ultrasonic Test Bondline Thickness (UTBOT) system that acquires ultrasonic data using a combination of hardware including a low noise pulser/receiver and high speed wide dynamic range digitizer. A high frequency wideband ultrasonic transducer is used that is small enough to reach difficult areas of interest under stringers and intersection of bonded stiffeners. Iterative pattern recognition signal processing technique using progressive model matching based on reflection and attenuation coefficients is employed.

The challenge using an ultrasonic transducer (UT) technique to-date has been intractable due to thin adhesives and thin metal sheets. These conditions create confounding number and amplitude of UT reflections and multiples from the numerous layer interfaces. Prior art using ultrasonic methods are limited to thicker adherends and thicker adhesives not suited to the lightweight and high performance structures used in aerospace. The technology described herein can be integrated into a portable personal computer suited for production floor access to large assemblies and includes direct reading requiring no special inspector certification. Thickness measurements can be recorded in a spreadsheet correlated to user desired locations on a bond assembly drawing.

The technology described herein includes low noise UT pulser/receiver, low noise high speed wide dynamic range digitizer (e.g., 16-bit 1 GS/s) using a high frequency probe (e.g., 20-50MHz wideband short pulse transducer). The signal processing algorithm of the technology involves a progressive model matching method using reflection and attenuation coefficients of the multiple layers and distinguishes the multitude of reflection peaks of true adhesive reflections, multiples, and second metal layers. Due to the small amplitude of reflections of interest averaging and wavelet filtering can be applied.

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

It should also be appreciated that some of the components described in the figures(and throughout any other portion of this document) may be referred to as singular or plural components. However, these descriptions are for illustration purposes and are non-limiting. For example, if a component is referred to as a system, it should be understood that the system could comprise a single component, or could be multiple components (included distributed components). Likewise, if a component is referred to as a plurality, it should be appreciated that the component may also be implemented via a single component as well.

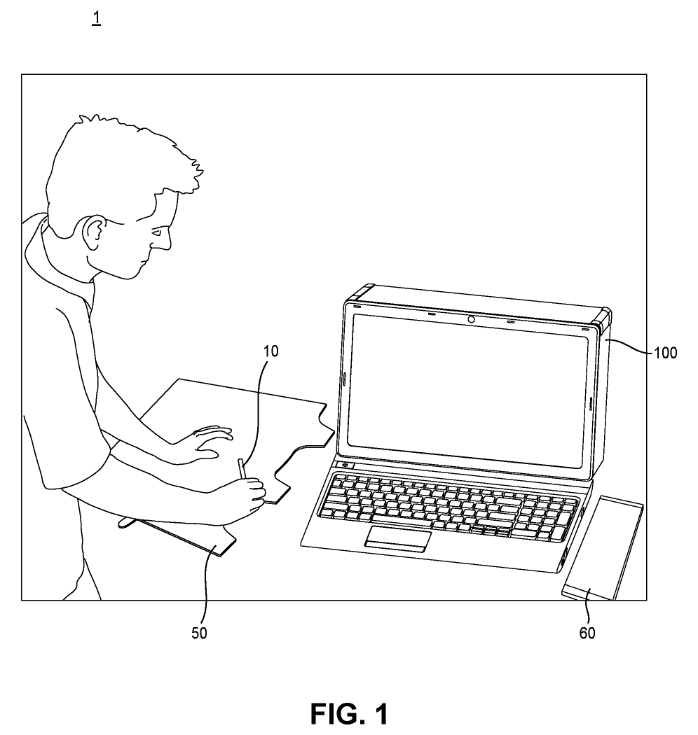

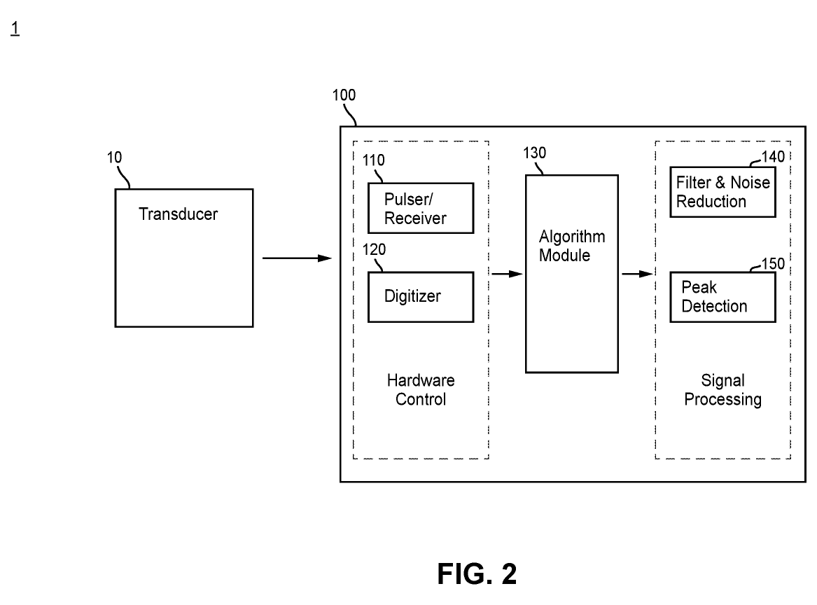

FIG. 1 shows a non-limiting example diagram of a system 1 for testing, among other aspects, bondline thickness with a portable system suitable for a manufacturing environment. The example shown in FIG. 1 depicts a user operating a transducer 10 on an object 50. The object 50 could, in a non-limiting example, be a piece of metal of an aircraft (or any other type of moving vehicle/craft). The object 50 may include multiple layers of metal sheets where adhesive layers bonding each sheet exist in between.

The user can operate transducer 10 on different portions of object 50 to measure thickness of each metal and adhesive layer. For example, if object 50 constituted a portion of an airplane having a window, the user can move transducer 10 over different portions of the metal structure and obtain measurements at different points (e.g., on the metal body, near edge portions surrounding the window or stiffening elements). These examples are of course non-limiting and the user can operate transducer 10 over any type of object 50 in order to obtain measurements associated with the object 50.

A user may also operate transducer 10 to perform various measurements on reference object 60. In one example embodiment, reference object 60 may include a piece of metal (e.g., having different metal layers with thick adhesive on backside) where different portions of the metal may be labeled to indicate “known” top metal thicknesses to standardize the system in compensation for transducer, system and temperature variations. A user could, for example, operate transducer 10 on any such portions of object 60 to check the measured amount to ensure that transducer 10 as well as any other component of system 1 is operating properly.

System 1 may also include measurement system 100 that, in some embodiments, is operatively couples to transducer 10. For example, transducer 10 may be connected via a wired connection directly to system 100. Alternatively, transducer 10 may transmit/receive data to/from system 100 in a wireless manner. These examples are of course non-limiting and transducer 10 may communicate with system 100 in any fashion.

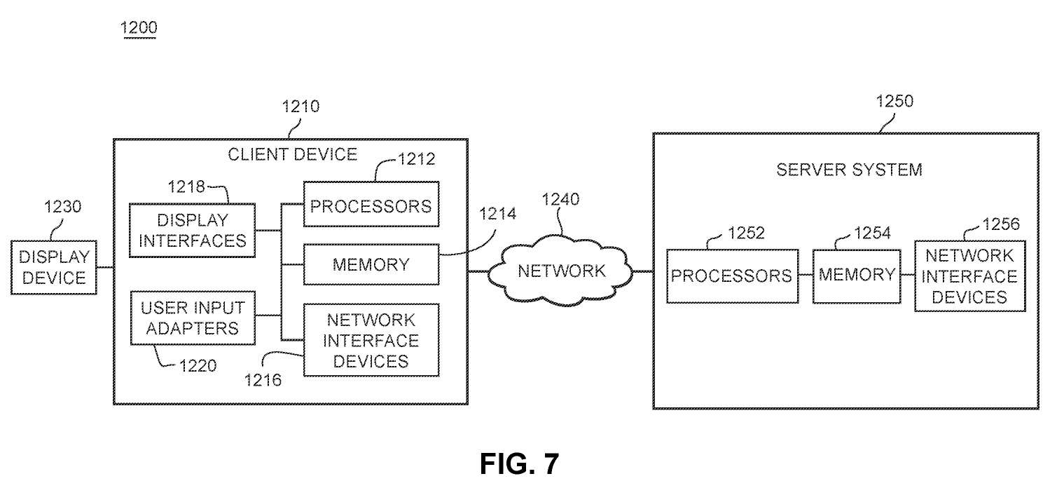

Measurement system 100 could include various hardware components for processing data in association with transducer 10 and then generating resultant output. In one example embodiment, measurement system 100 may include general hardware computer components (as detailed further with respect to FIG. 7), and may also include other hardware components specifically used for measuring thickness, as discussed herein. System 100 may also produce various types of output including, but not limited to, a user interface that can generate any manner of output. Measurement system 100 may also, in some embodiment, communicate with one or more server systems (not shown) in order to operate in conjunction with the server systems for performing various tasks. Hardware for such server systems is generally discussed also with respect to FIG. 7.

FIG. 2 shows a non-limiting example block diagram of different components in system 1. In particular, FIG. 2 shows elements associated with measurement system 100 and transducer 10. As discussed herein, transducer 10 can communicate information to/from system 100. In one example embodiment, transducer 10 could include a highly damped 20-25 megahertz (MHz) ultrasonic transducer. The transducer 10 can be a device that generates or senses ultrasound energy and can be configured to transmit and/or receive. As an example, the transducer 10 can convert electric signals into ultrasound and transmit the same, where transducer 10 can also convert ultrasound into electrical signals and receive the same.

It should be appreciated that transducer 10 can be configured to perform ultrasonic testing. One of ordinary skill would understand that ultrasonic testing is a form of non-destructive testing techniques based on the propagation of ultrasonic waves in the object or material tested. In most common ultrasonic testing applications, very short ultrasonic pulse-waves with center frequencies ranging from 0.1-15 MHz, and occasionally up to 50 MHz, are transmitted into materials to detect internal flaws, characterize materials, or measure thickness of the materials.

As discussed herein, measurement system 100 can communicate data to/from transducer 10 for performing calculations associated with thickness measurement. Among various hardware components as shown, for example, with respect to FIG. 7, system 100 may include other hardware components including, but not limited to, a pulser/receiver 110 and/or digitizer 120. These examples are of course non-limiting and system 100 may include any other type of hardware components.

Pulser/receiver 110 may include a pulser/receiver card having a Peripheral Component Interconnect (PCI) card format. The pulser/receiver 110 can be used in ultrasonic testing systems, and can be implemented using a portable computer(s). The pulser/receiver 110 may perform instrument functions including adjustable damping, gain, pulse amplitude, pulse energy, pulse repetition rate, high pass filters, low pass filters, echo or through mode select (dependent on pulser selection), and pulser trigger source.

Digitizer 120 may include a 16-bit, 1 GS/s digitizer. The digitizer 120 may include two or four 16-bit channels at 1 GS/s and 600 MHz bandwidth, with PCIe data streaming rates up to 5.2 GB/s. The digitizer 120 may also include a type of PCI card format that can be implemented using a portable computer(s).

The measurement system 100 can include an algorithm module 130 configured to execute an algorithm associated with system 100. In one example embodiment, algorithm module 130 may include an algorithm for performing the ultrasonic bondline thickness test. The algorithm module 130 includes processes and steps discussed herein.

The measurement system 100 can also include various signal processing components. For example, measurement system 100 may include filter and noise reduction 140 module and peak detection 150 module. These examples are non-limiting, and system 100 may include any other various components/modules in association with signal processing.

The filter and noise reduction 140 module may include wavelet filter noise reduction (e.g., sharp roll-off with no phase delay) and can be used in association with digitizer 120, among other components. In general, filter and noise reduction 140 module can be used to help eliminate or reduce noise in the signal processing associated with transducer 10.

The peak detection 150 module can be configured to detect (or analyze) various peaks (e.g., of waveforms produced as output from signal processing). For example, peak detection 150 module can include signal processing algorithms based on reflection/transmission coefficients of metal and adhesive used to analyze complex reflections. In one example embodiment, peak detection 150 can detect various peaks (e.g., in waveforms) meeting certain thresholds and perform temporal matching. Peak detection 150 module can also distinguish between adhesive, multiples, and second bondline response using progressive model matching. These examples are of course non-limiting and peak detection 150 module can perform other various types of processing. It should also be appreciated that any of the components shown in FIG. 2 may be performed by hardware, software, or a combination of hardware and software.

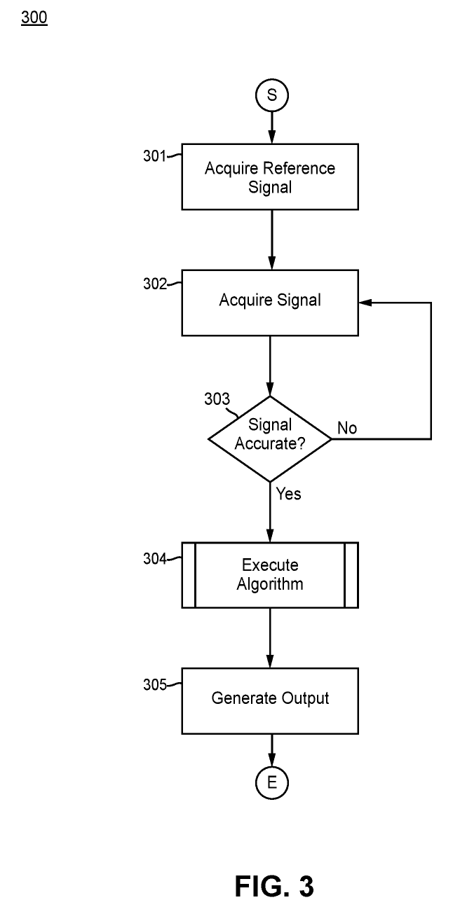

FIG. 3 shows a non-limiting example flowchart for processes associated with system 1. In one example embodiment, FIG. 3 shows a process 300 for performing the thickness measurement test(s) discussed herein. Process 300 begins by system 1 acquiring a reference signal (at action 301). In one example embodiment, a user may operate transducer 10 to perform measurement on an object (e.g., reference object 60) and acquire an initial signal used to reference against later signals that are acquired.

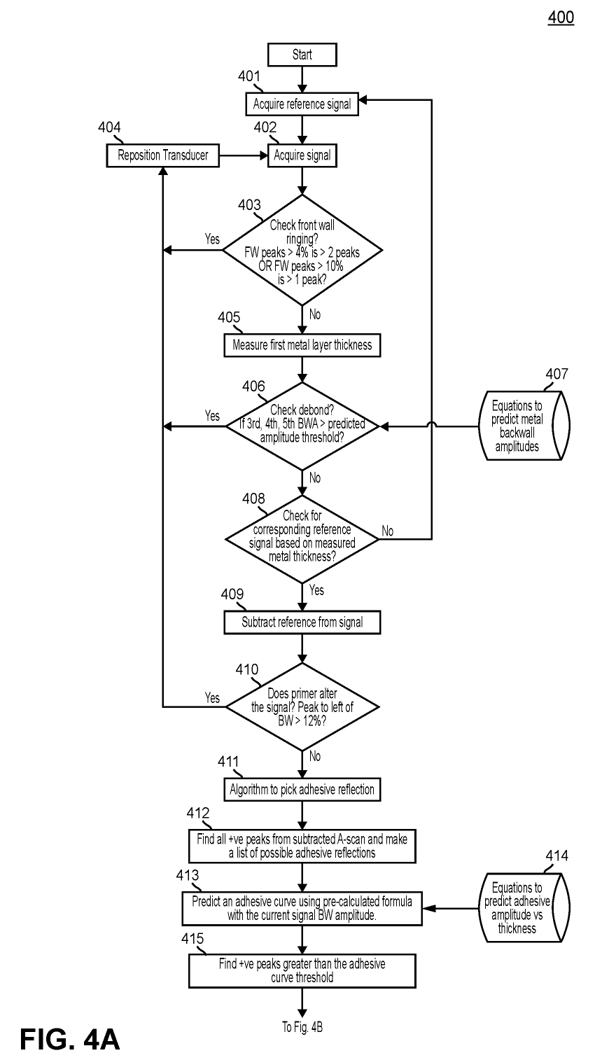

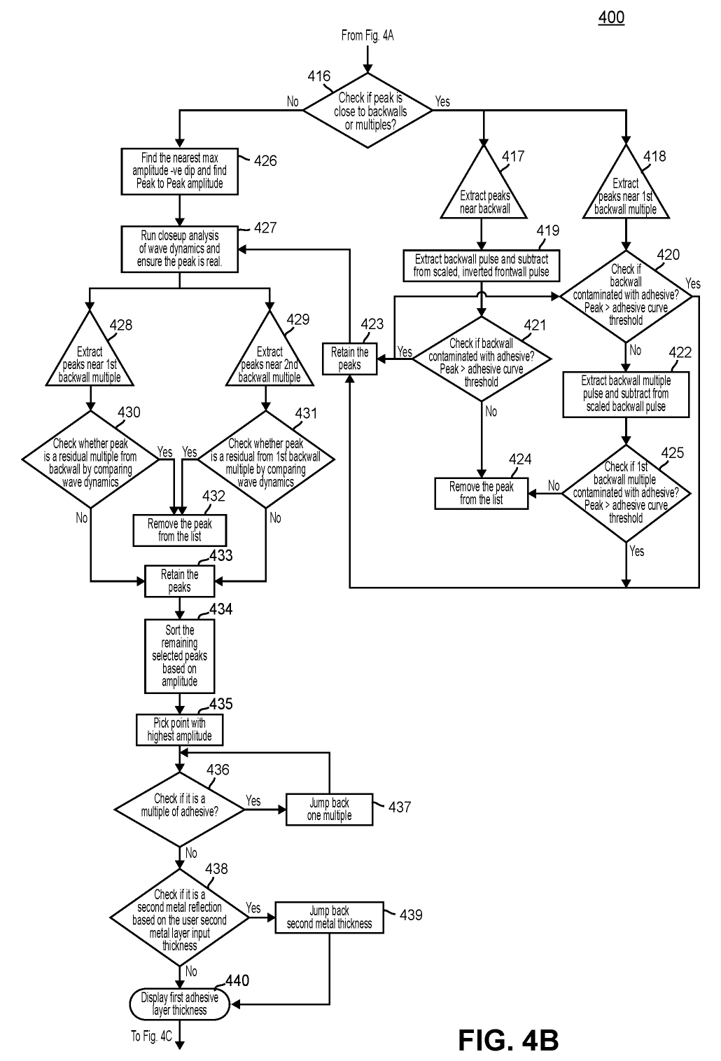

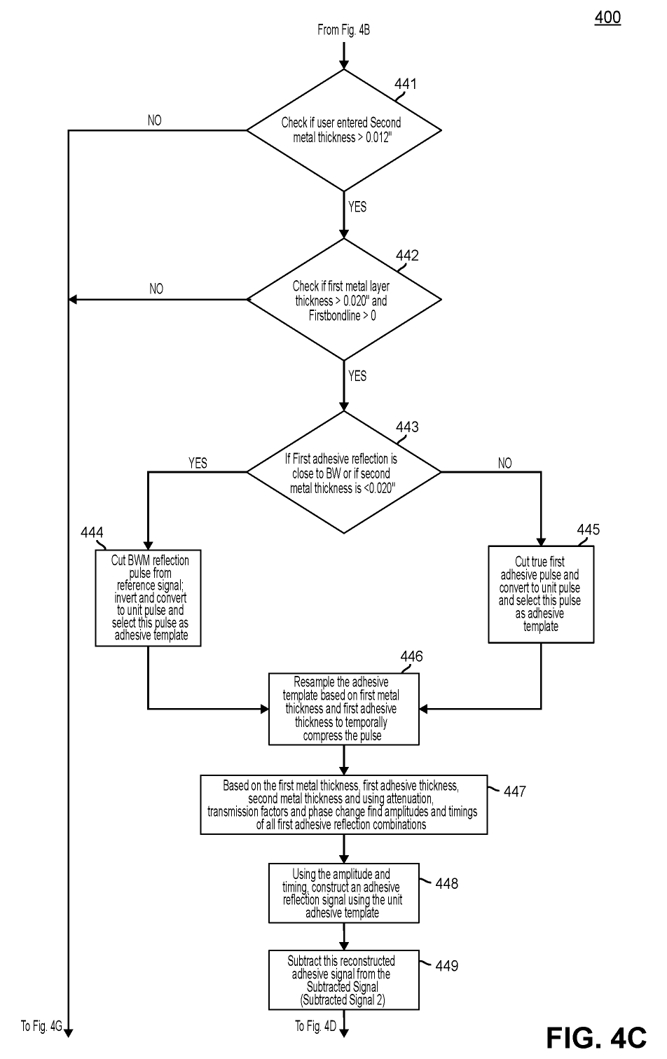

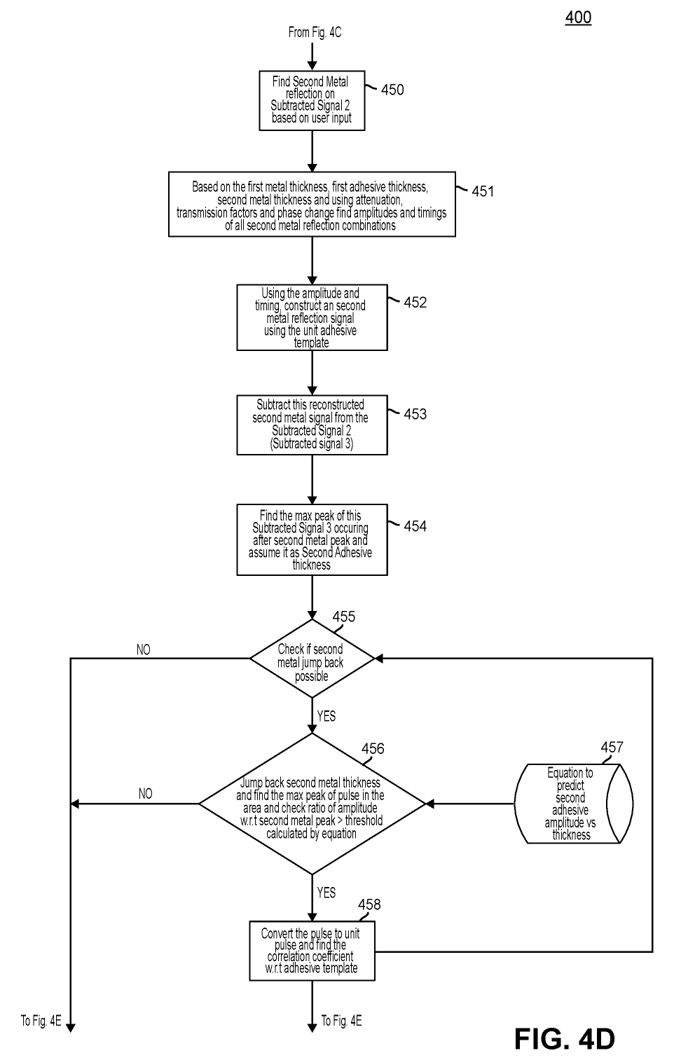

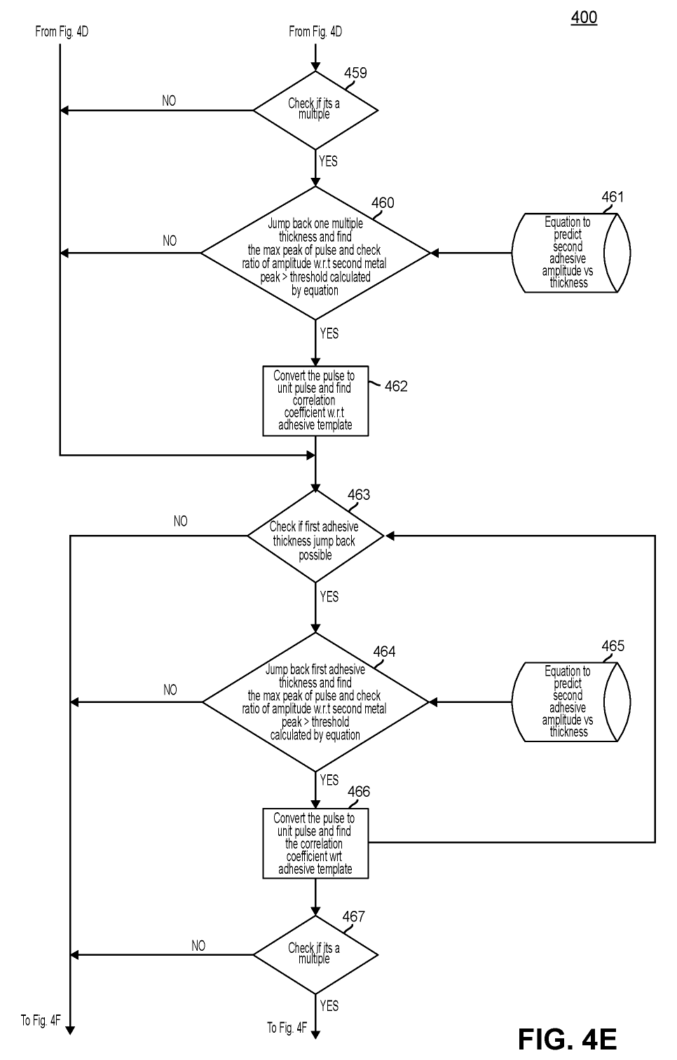

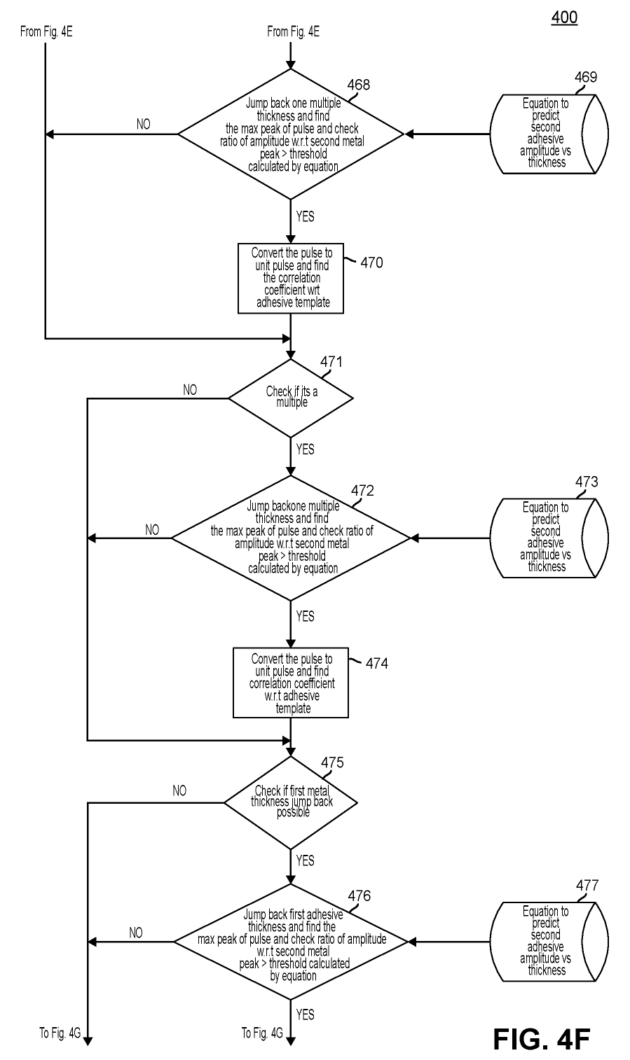

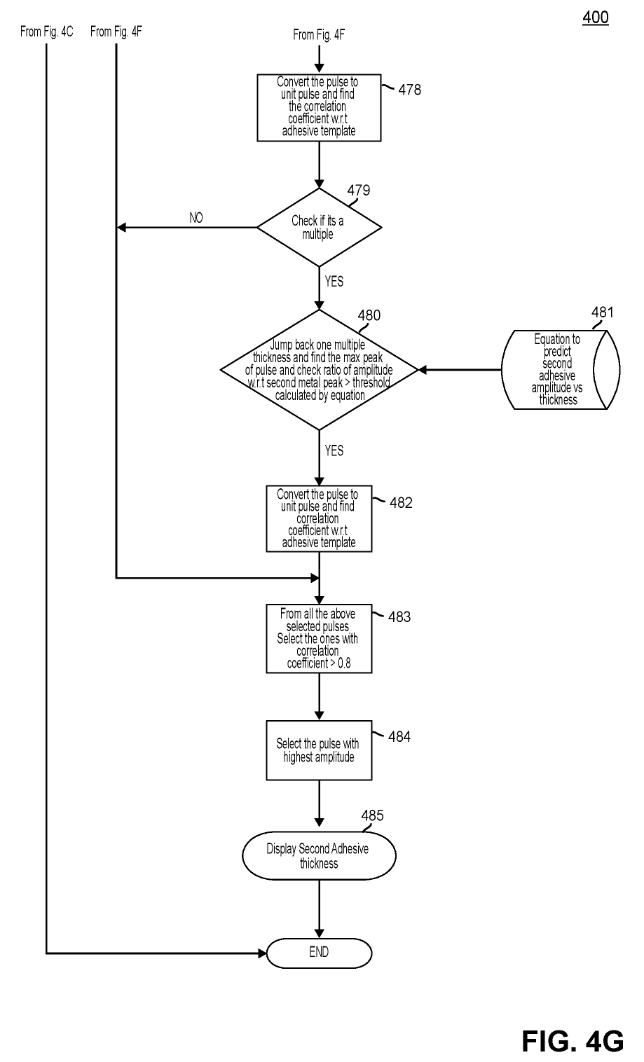

In more detail, the process 300 continues (at action 302) where system 1 acquires a subsequent signal(s). In one example embodiment, signal(s) acquired at action 302 can include various signals used in performing thickness measurement and testing on object 50. For example, a user can acquire signals from transducer 10 when measuring thickness on various components of the object 50. System 1 can (at action 303) determine if the signal processing is working correctly (as discussed in more detail with respect to FIGS. 4A-G). For example, system 1 may determine if the measurements obtained from transducer 10 are within an acceptable range/threshold. If the measurements are not within acceptable parameters, system 1 may require the user to re-obtain signals (at action 302) by performing certain actions including, but not limited to, slightly re-positioning transducer 10 for improved test surface finish.

If the acquired signals are proper, system 1 may execute algorithm (at action 304) associated with the thickness measurement test. That is, system 1 may obtain various signals from transducer 10 and then use the hardware and/or software components of system 1 (e.g., as shown in FIGS. 2 and 7) and perform various measurements and tests. The operations associated with the algorithm are discussed in more detail, at least, with respect to FIGS. 4A-G.

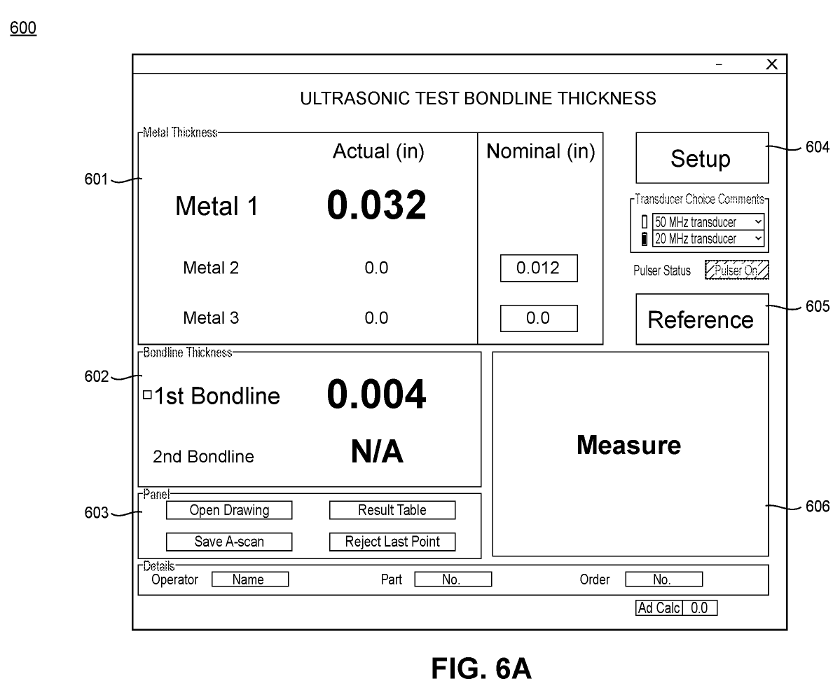

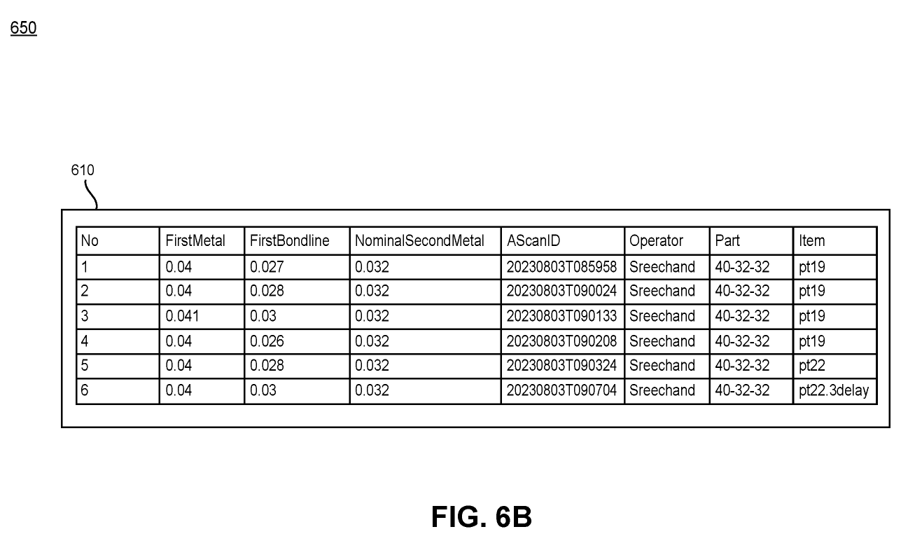

Upon executing the algorithm, system 1 may (at action 305) generate associated output. In one example embodiment, system 1 may generate a user interface (e.g., user interface 600, as shown in FIG. 6A) that conveys various information to a user. System 1 may also generate other output data, in conjunction with or separate from, the user interface. For example, system 1 may generate output data, or image data providing information associated with execution of the algorithm in operation of system 1.

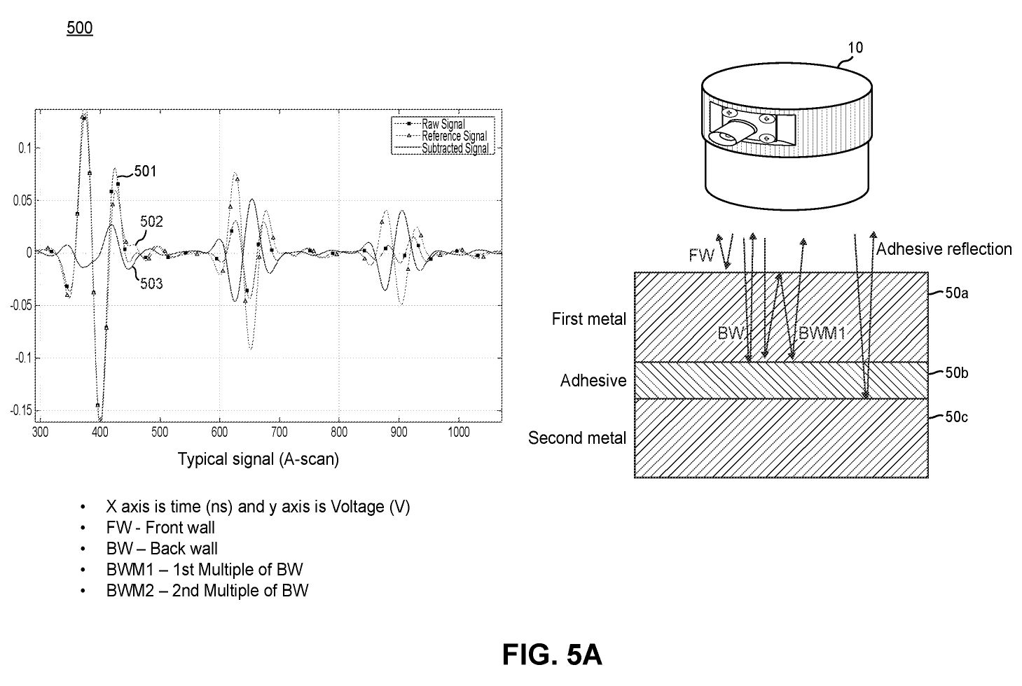

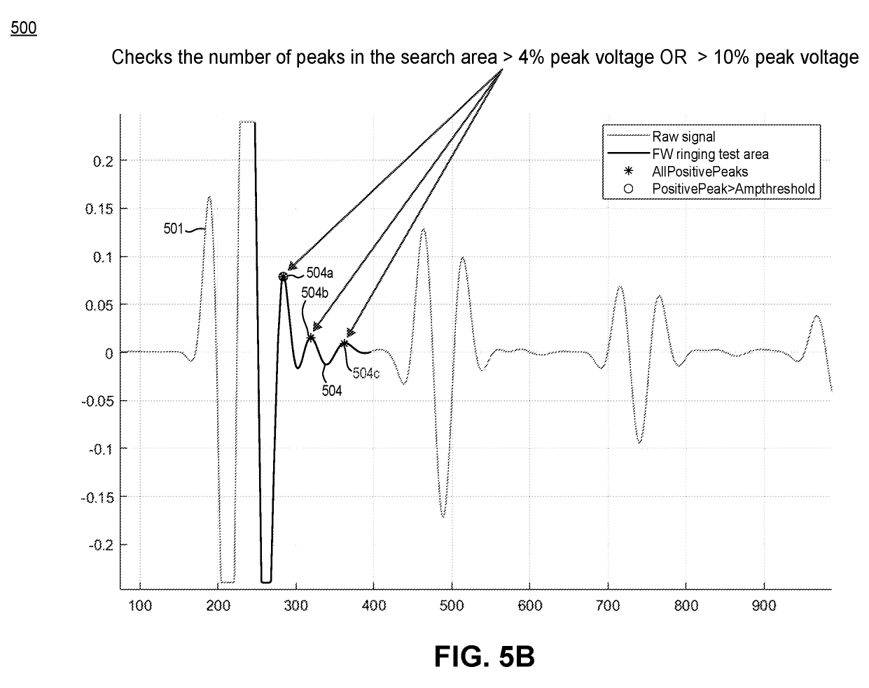

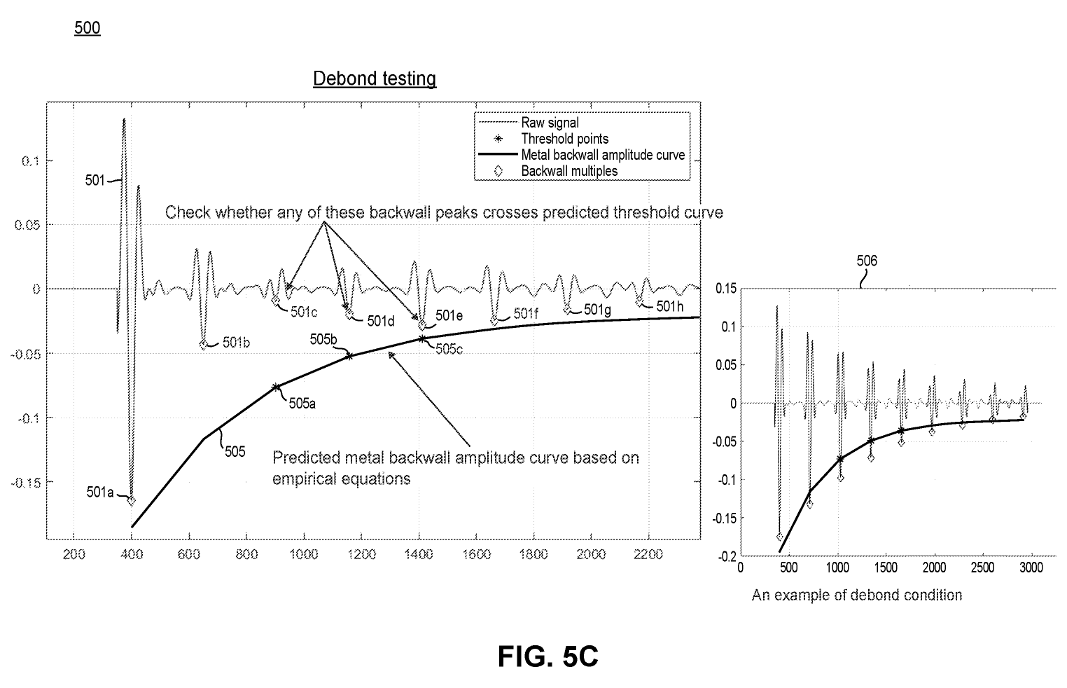

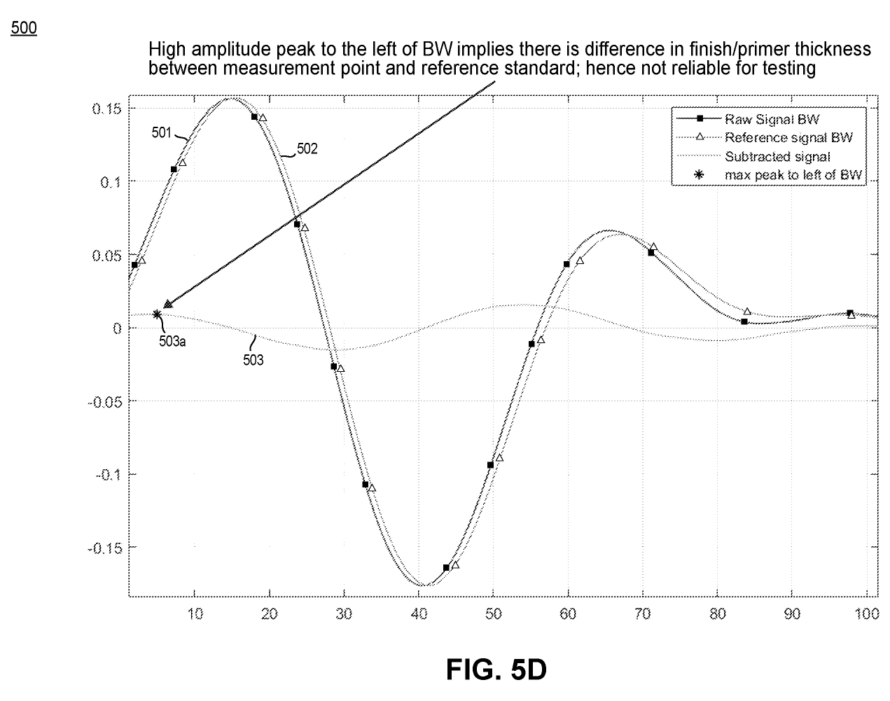

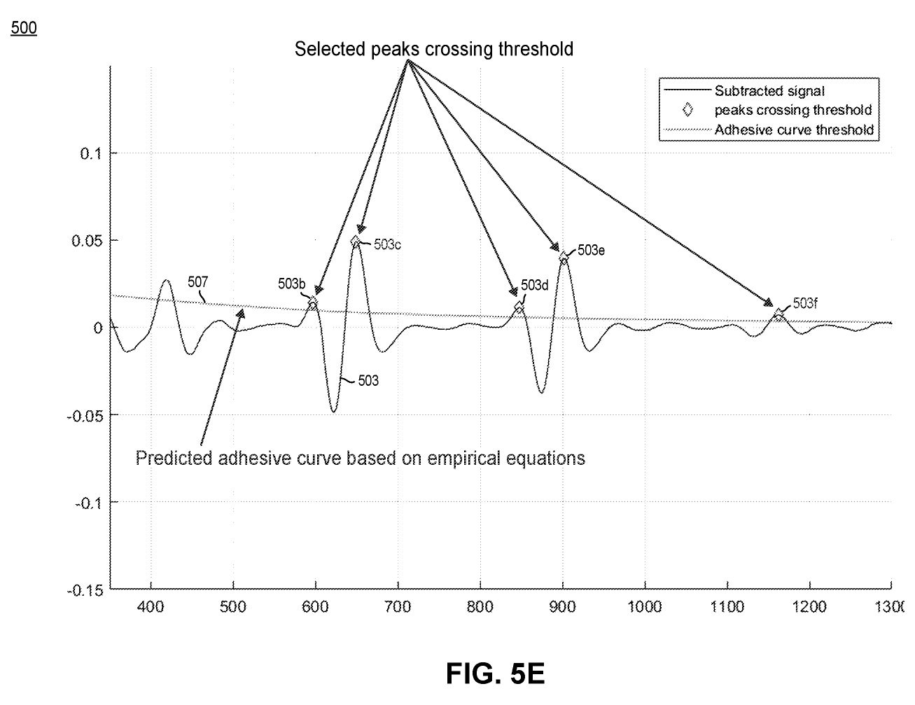

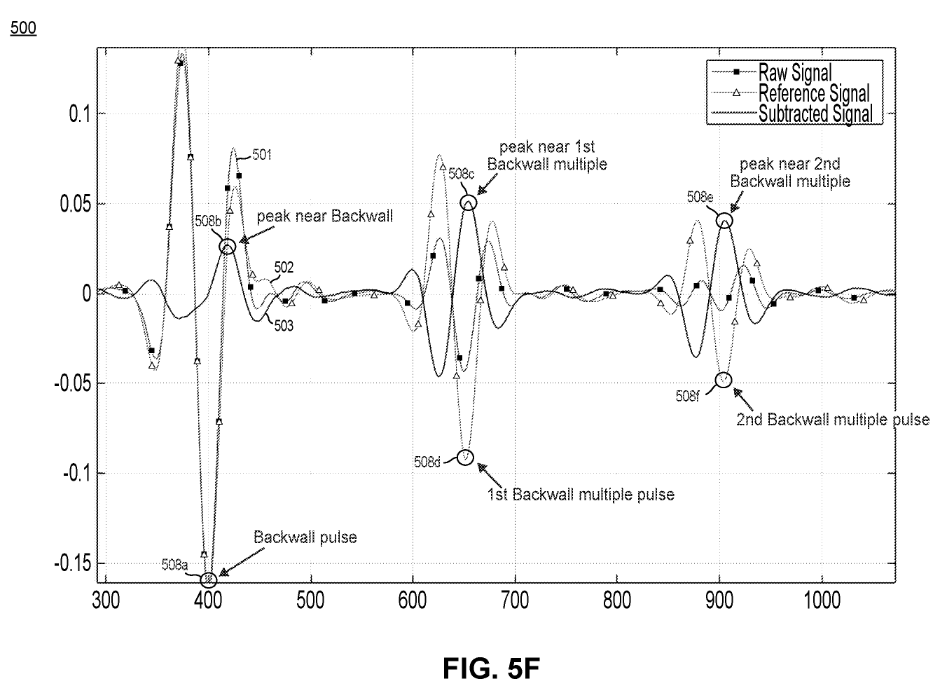

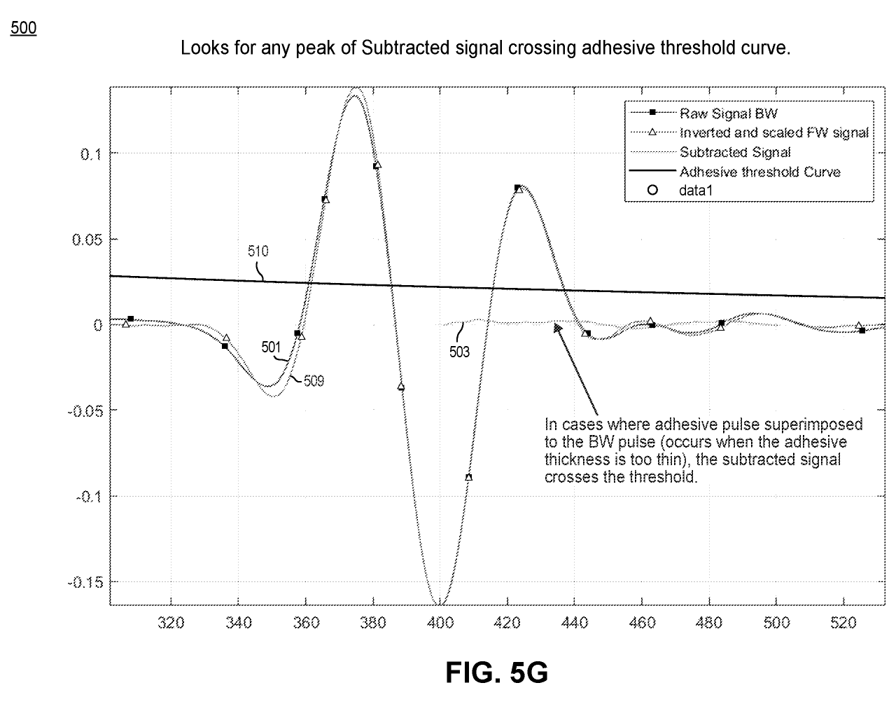

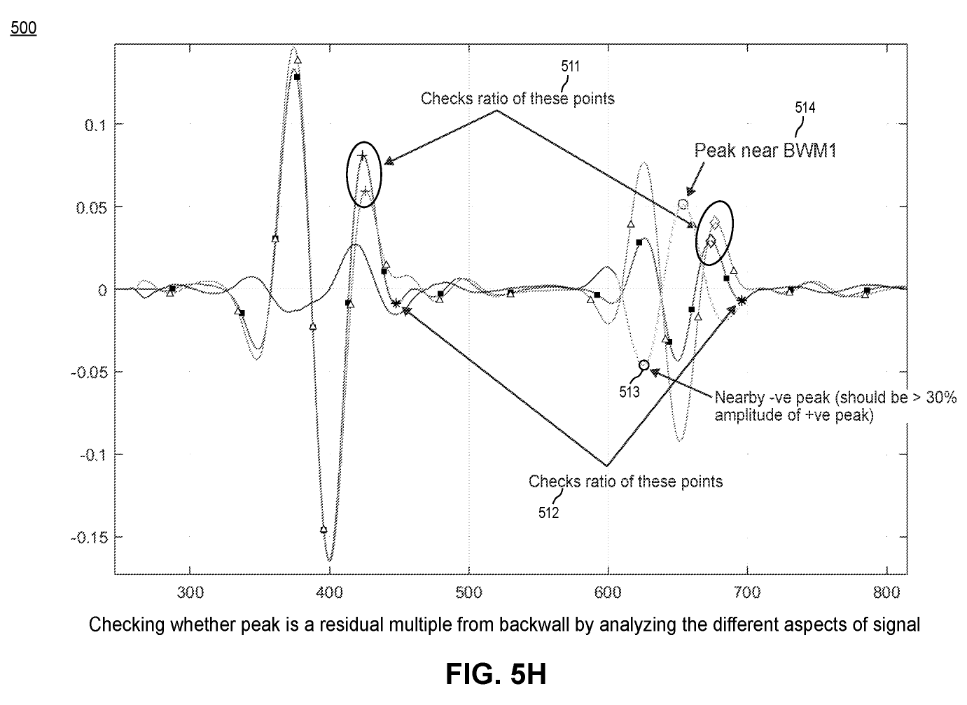

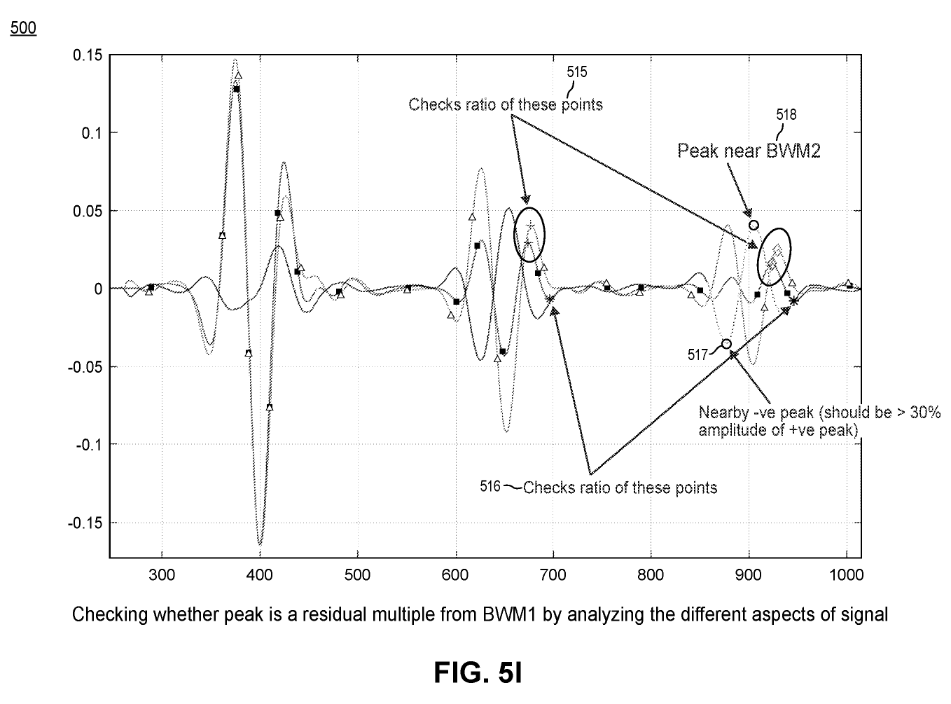

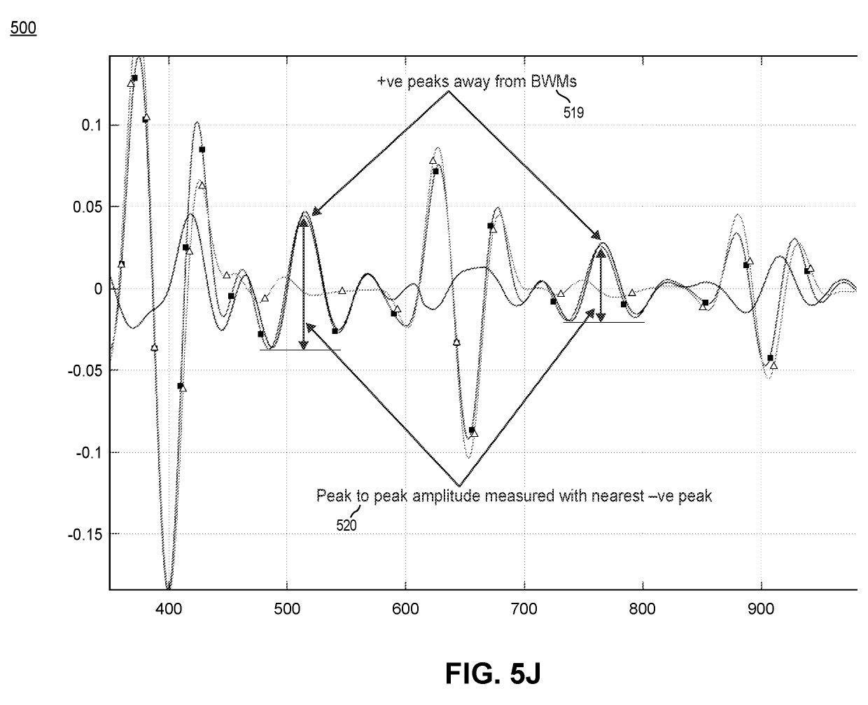

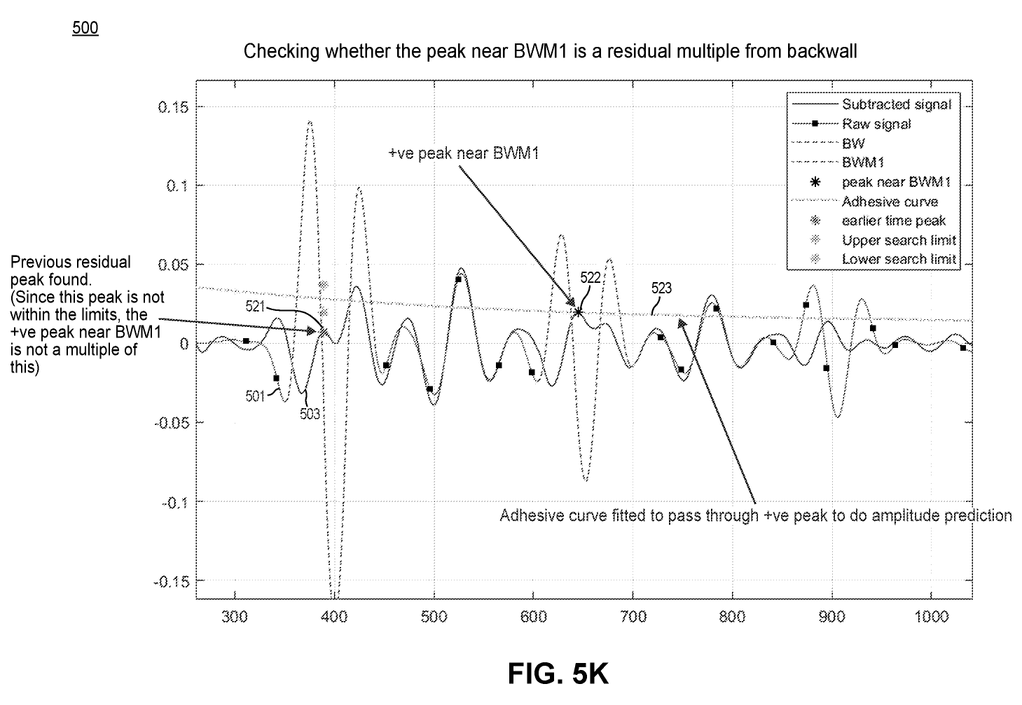

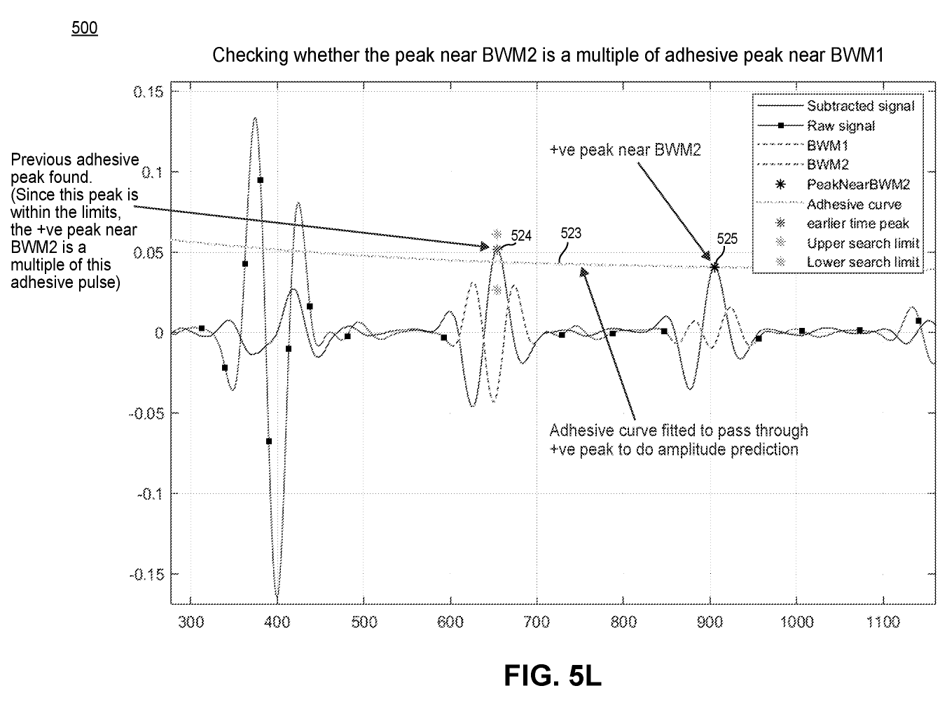

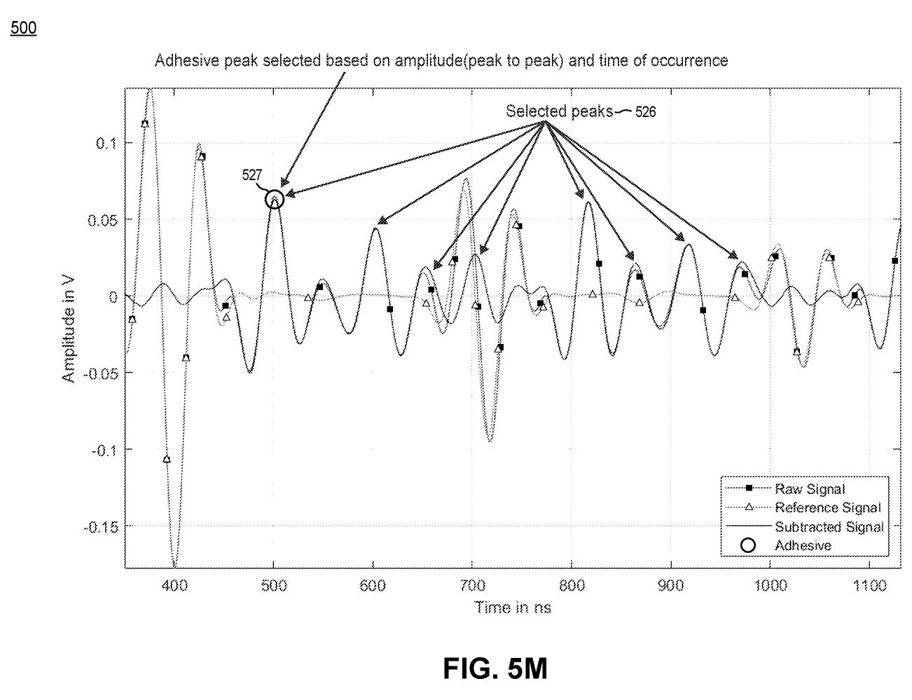

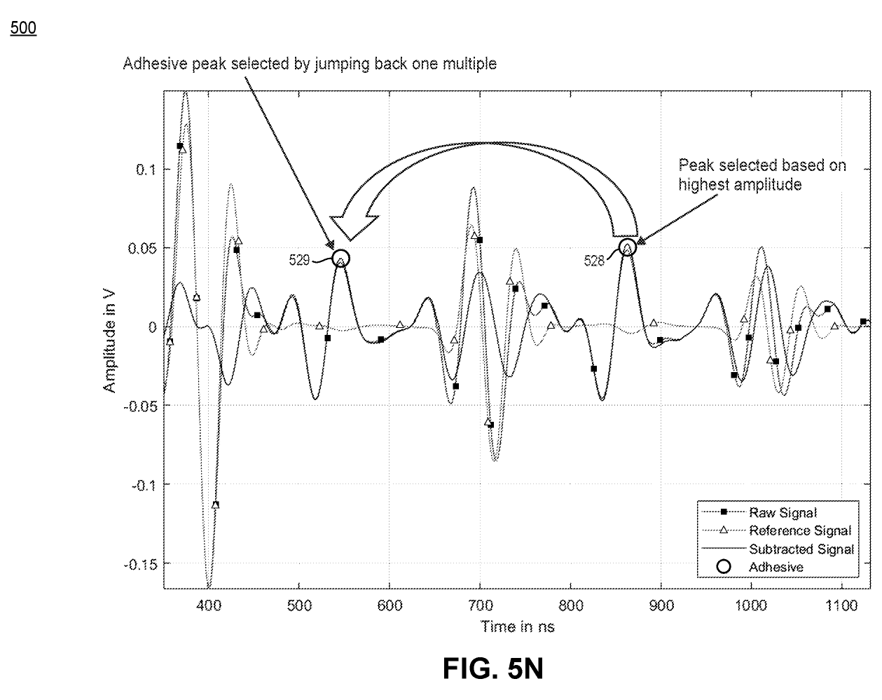

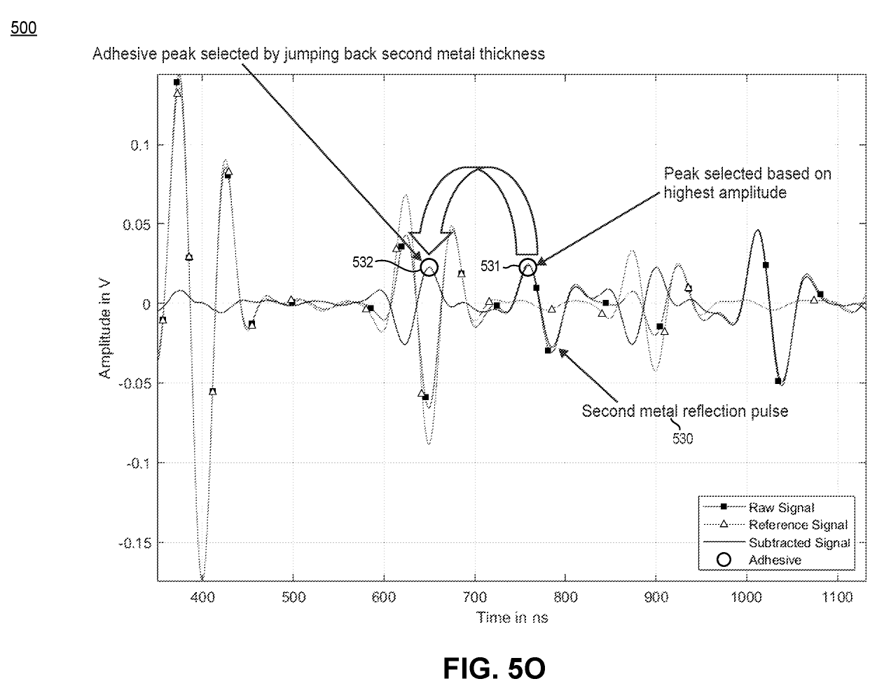

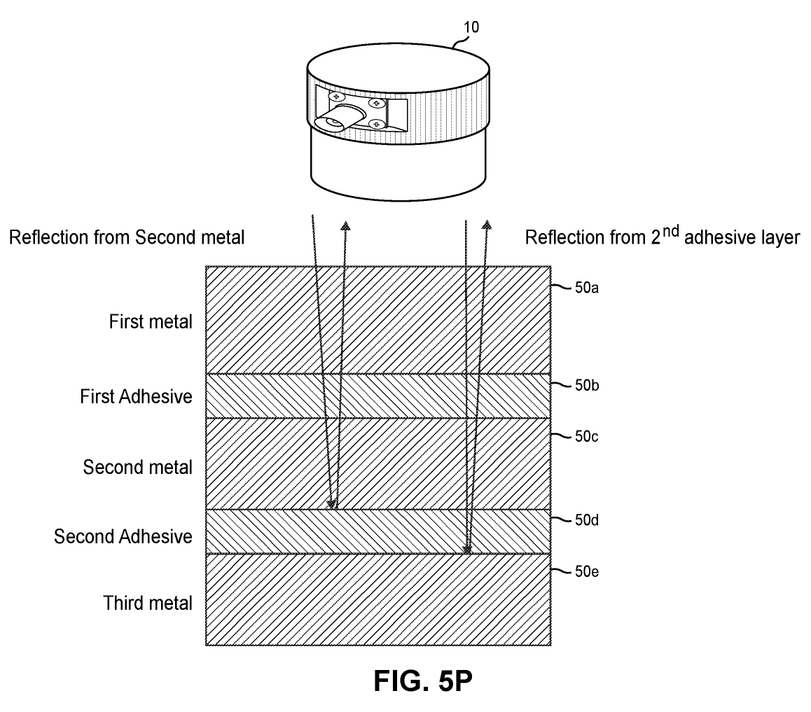

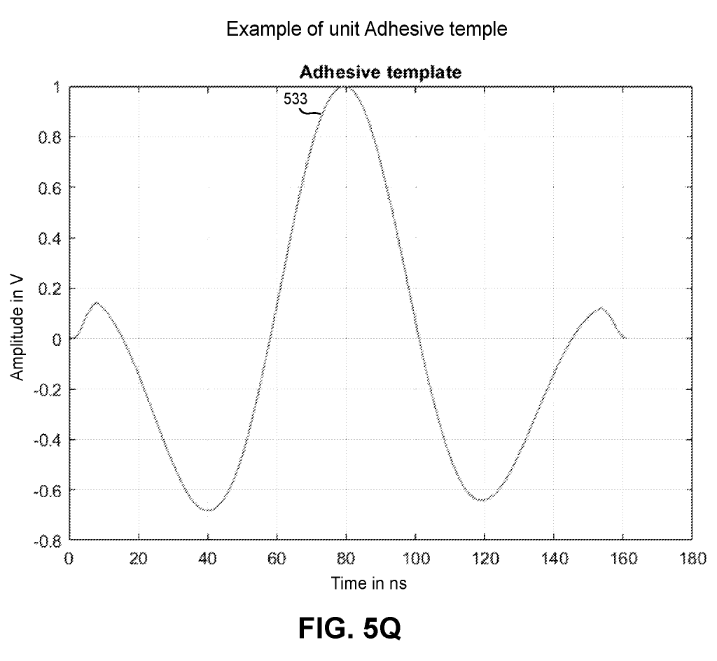

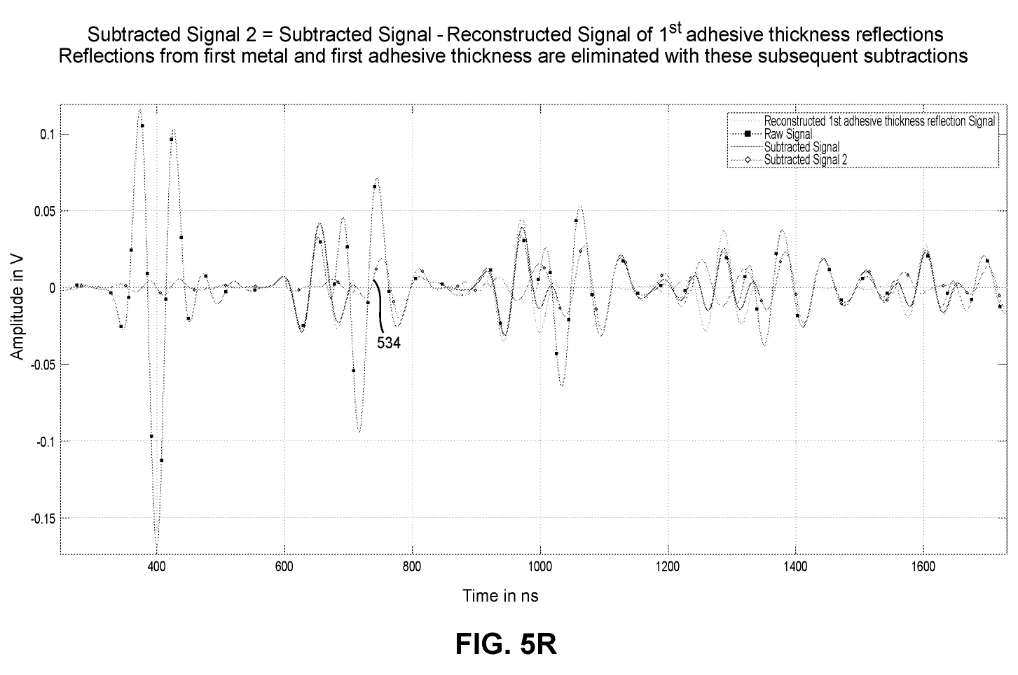

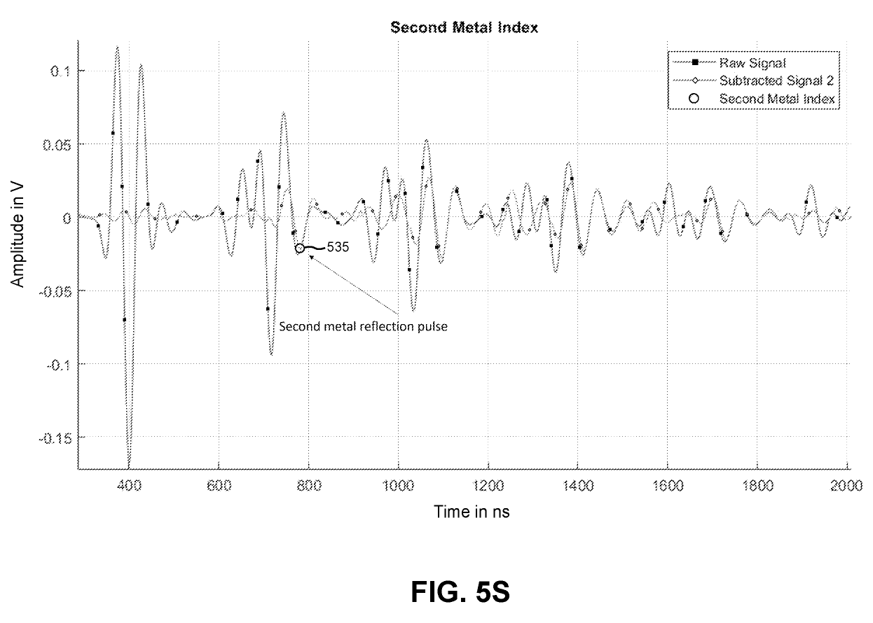

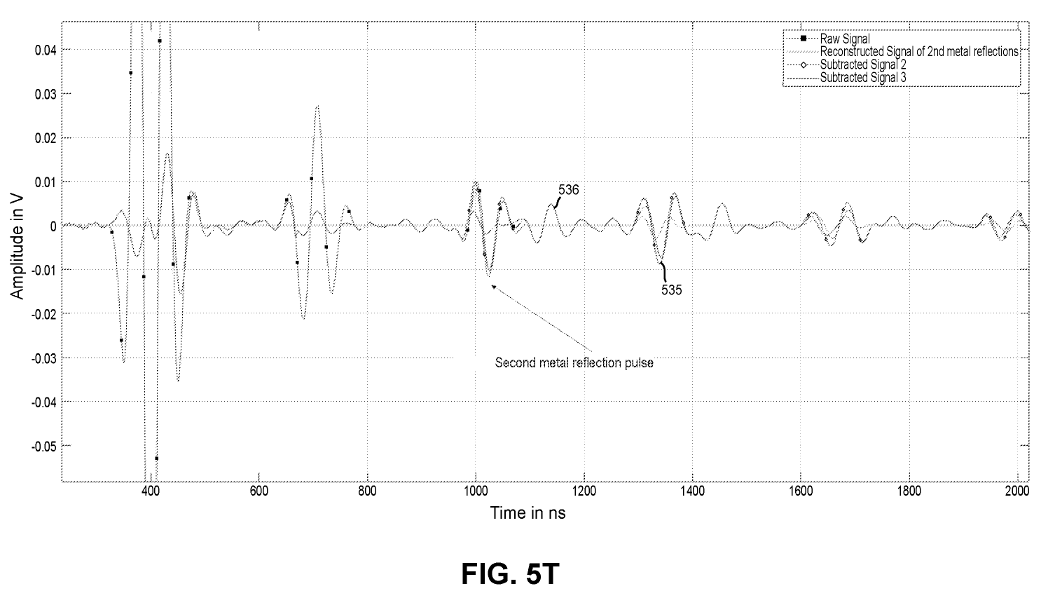

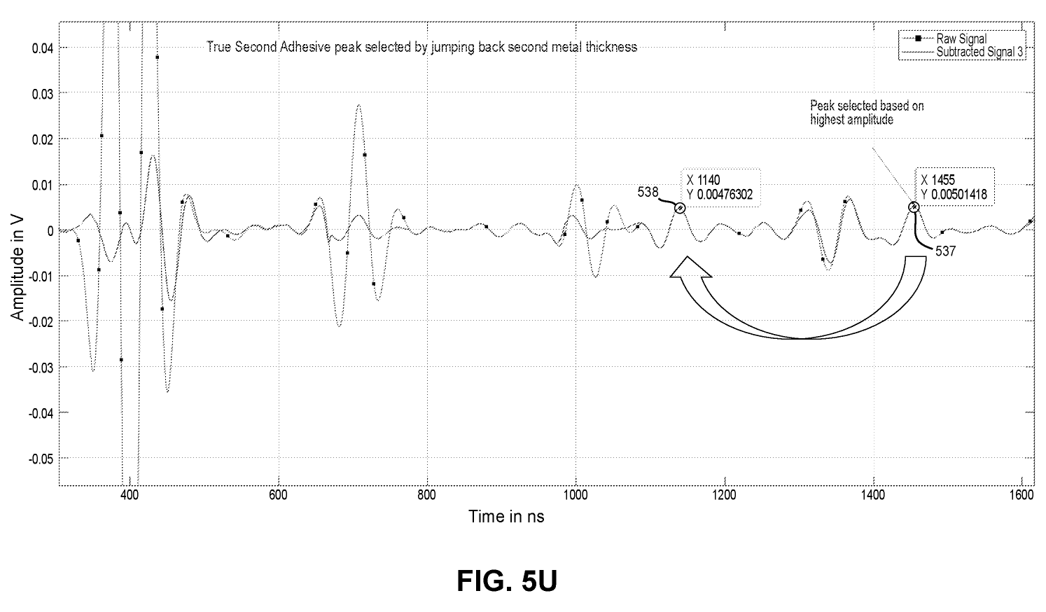

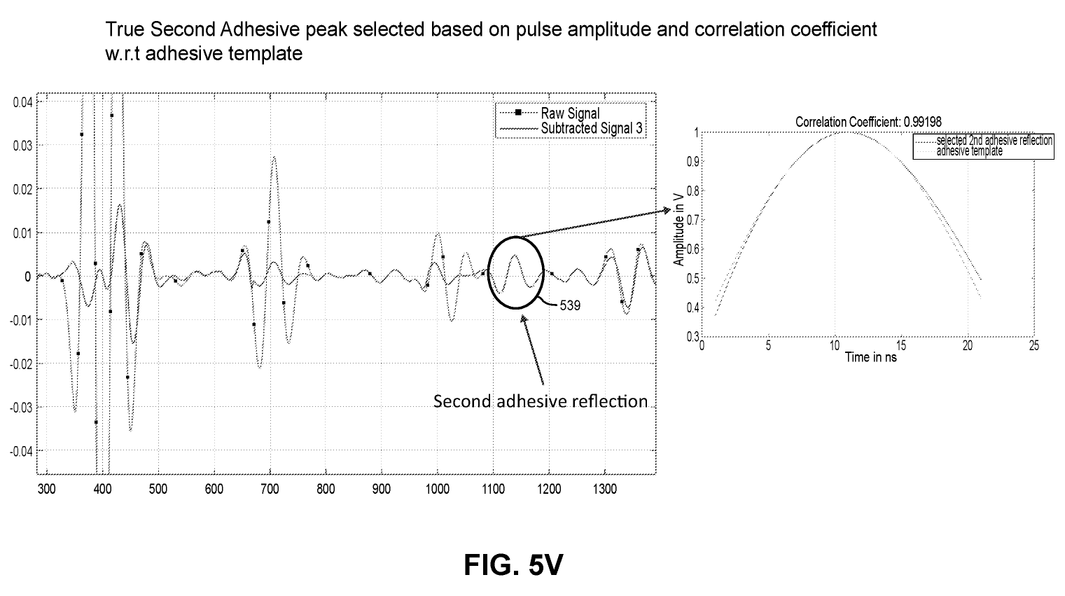

FIGS. 4A-G show non-limiting example flowcharts for processes associated with system 1, while FIGS. 5A-V show non-limiting example diagrams of analysis performed in association with the processes of FIGS. 4A-G. The processes shown in FIGS. 4A and 4B, in a non-limiting example embodiment, include various aspects of the algorithm for performing the thickness measurement test. It should be appreciated that some of the actions shown in FIGS. 4A-G may “overlap” those shown in FIG. 3, but provide further detail as to the processes depicted in FIG. 3.

The process begins (at action 401) by system 1 acquiring a reference signal. As discussed herein, in one example embodiment, a user may operate transducer 10 to perform measurement on an object (e.g., reference object 60) and acquire an initial signal used to reference against later signals that are acquired. The process may then proceed (e.g., to action 402) to acquire a subsequent (e.g., non-reference) signal where one or more signals may be obtained. FIG. 5A shows an example diagram depicting example waveform(s) associated with different analyzed signals.

In the example shown in FIG. 5A, an object 50 may be scanned (e.g., using transducer 10) where different signals are obtained. In operating a transducer 10 on object 50, various signals may “bounce” internally 50a-c and between different layers of object 50 which for thin adhesives & adherends complicates thickness characterization. For example, one or more signals may traverse a first metal layer 50a, an adhesive layer 50b, and/or a second metal layer 50c of object 50. For example, one signal may be indicative of a “front wall” reflection, while another signal may be indicative of a “back wall” reflection. Another signal could be indicative of a “first multiple of the back wall” reflection, while yet another signal could be indicative of a “second multiple of the back wall” reflection.

Different waveform data may be produced in this process, and one “scan” is shown to include a raw signal waveform 501, a reference signal waveform 502, and/or a subtracted signal waveform 503. That is, a graph can be generated showing waveforms 501-503 where various processing and calculating on such values is described herein.

Upon acquiring the signals, system 1 may analyze the front wall ringing (e.g., at action 403) to determine if certain peaks satisfy one or more thresholds. FIG. 5B shows an example graph with raw signal waveform 501 where certain portions qualify as a front wall ringing test area waveform 504. System 1 may check peaks 504a-c of waveform 504 to determine if the peaks satisfy one or more criteria. In the example shown in FIG. 5B (and discussed with respect to action 403), system 1 may determine if the number of peaks in a search area (of waveform 504) are greater than 4% peak voltage (greater than 2 peaks) or greater than 10% peak voltage (greater than 1 peak). It should be appreciated that peaks 504a-c in FIG. 5B represent positive peaks, as a non-limiting example dependent on the transducer characteristics.

It should be appreciated that the analysis performed (at action 403) may satisfy the associated criteria and thus system 1 may not be obtaining a “high quality signal.” As such, system 1 may provide indication (e.g., at action 404) for the user to reposition the transducer 10 where the system will acquire further signals and perform associated analysis. Otherwise, system 1 may (at action 405) measure a first metal layer thickness (e.g., of object 50). Upon measuring the first metal layer thickness, system 1 will obtain further signals where further waveform data may be analyzed.

FIG. 5C shows a non-limiting example of “debond testing” (performed at action 406) where system 1 may determine if various backwall peaks are greater than a predicated amplitude threshold. For example, and as shown in FIG. 5C, raw signal waveform 501 may be analyzed to determine if any backwall multiples 501a-g cross a predicted threshold curve of metal backwall amplitude curve 505. That is, metal backwall amplitude curve 505 may have various threshold points 505a-c where analysis is performed to determine whether some (or all) of multiples 501a-g “cross” the threshold points. An example debond condition is shown in graph 506 where at least six multiples cross the associated thresholds. It should be appreciated that the metal backwall amplitude curve 505 may be derived based on empirical equations (e.g., shown as equations 407 to predict metal backwall amplitudes for a debonded sheet).

If certain multiples cross the associated thresholds, system 1 may (at action 404) indicate to reposition the transducer 10 (e.g., in order to acquire new signals). Otherwise, system 1 may (at action 408) perform analysis to check for a corresponding reference signal 502 based on a measured metal thickness. If the corresponding reference signal 502 exists, system 1 can (at action 409) subtract the reference signal 502 from the various waveforms.

System 1 may (at action 410) determine if a primer (or finish) alters a signal peak to a left of a backwall greater than a threshold value (e.g., 12%). FIG. 5D shows a non-limiting example diagram determining if the primer/finish thickness alters the signal peak to the left of the backwall beyond a certain value. In one example embodiment, subtracted signal waveform 503 can be generated based on a difference between raw signal (e.g., of the backwall) waveform 501 and reference signal (e.g., of the backwall) waveform 502. System 1 may determine a max peak 503a to the left of the backwall (e.g., as presented in the subtracted signal 503) where a value of max peak 503a can be analyzed to determine if it exceeds a threshold value (e.g., 12%). If the max peak 503a value is greater than a threshold value, system 1 (at action 404) may again indicate to reposition transducer 10. In particular, a high amplitude peak to the left of the backwall implies a difference in primer (or finish) thickness between a measurement point and a reference standard (and thus may be unreliable for testing).

If max peak 503a does not satisfy a threshold value, system 1 may (at action 411) apply (or determine) an algorithm to pick an adhesive reflection. System 1 may further (at action 412) find all positive peaks from a subtracted A-scan and assemble a list of possible adhesive reflections. System 1 may then (at action 413) predict an adhesive curve using a pre-computed formula with a current signal (e.g., backwall) amplitude. Such predication may employ various equations 414 to predict adhesive reflection amplitude versus adhesive thickness.

System 1 may (at action 415) find positive peaks greater than the adhesive curve threshold. FIG. 5E shows a non-limiting example diagram of determining various peaks crossing a threshold curve. In the example shown in FIG. 5E, the graph depicts the subtracted signal waveform 503 having various peaks 503b-f where some (or all) of peaks 503b-f cross a threshold of an adhesive curve 507. It should be appreciated that adhesive curve 507 may be predicted based on empirical equations (e.g., as equations 414 to predict adhesive amplitude vs. thickness).

System 1 may (at action 416) determine if one or more peaks are close to backwalls or multiples. FIG. 5F shows a non-limiting example diagram where associated analysis may be performed. For example, system 1 may (at actions 417 and/or 418) extract peaks near a backwall and/or extract peaks near a first backwall multiple. FIG. 5F shows the associated raw signal 501, reference signal 502, and subtracted signal 503 where different peaks and pulses are indicated. For example, backwall pulse 508a is depicted where the combination of signals 501-502 reach their “lowest” negative peak, while backwall peak 508b (e.g., of a peak near the backwall) is shown at a first “high peak” generated in subtracted signal 503. Similarly, a first backwall multiple pulse 508d is depicted near a second “low” point of reference signal 502, while a peak 508c (e.g., of a peak near a first backwall multiple) is shown at a second “high peak” generated in subtracted signal 503. A second backwall multiple pulse 508f is depicted near a third “low” point of reference signal 502, while a peak 508e (e.g., of a peak near a second backwall multiple) is shown at a third “high peak” generated in subtracted signal 503.

In association with extracting peaks near a first backwall multiple (e.g., action 418), system 1 may (at action 420) determine if backwall(s) contaminated with adhesive reflection by, for example, determining if a peak is greater than a threshold curve. If the determination is positive, system 1 may retain peak(s) (at action 423), and if the determination is negative, system 1 may extract a backwall multiple pulse and subtract from a scaled backwall pulse (at action 422). System 1 may (at action 425) determine if a first backwall multiple is contaminated with adhesive (e.g., by determining if a peak from the subtracted signal at action 422 is greater than an adhesive curve threshold). If the determination is negative, system 1 may (at action 424) remove the peak from the list, and if the determination is positive, system 1 may (at action 423) retain the peak(s).

In association with extracting peaks near a backwall (e.g., action 417), system 1 may (at action 419) extract a backwall pulse and subtract from a scaled, inverted front wall pulse. System 1 may (at action 421) determine if a backwall is contaminated with adhesive reflection (e.g., determine if a peak from the subtracted signal at action 419 is greater than a threshold curve). If the determination is negative, system 1 may (at action 424) remove the peak from the list, and if the determination is positive, system 1 may (at action 423) retain the peak(s).

FIG. 5G shows a non-limiting example of different analysis performed in association with certain elements of the process shown in FIGS. 4A-G (e.g., actions 417-425). In the example shown in FIG. 5G, raw signal waveform 501 (e.g., of a backwall raw signal) is shown where an inverted and scaled front wall signal waveform 509 is displayed in association with waveform 501.

FIG. 5G also shows the subtracted signal 503 along with an adhesive threshold curve 510. System 1 may analyze for any peak of a subtracted signal crossing the adhesive threshold curve 510. In situations where an adhesive pulse superimposed to the backwall pulse (e.g., occurs when the adhesive thickness is too thin), the subtracted signal crosses the threshold. Such example determination can be used to carry out certain processes (e.g., actions 417-425) in FIGS. 4A-G. For example, the determinations associated with FIG. 5G may be used to determine if a backwall or backwall multiple is contaminated with adhesive reflection where removal or retainment of various peaks is then determined.

Upon removing or retaining various peaks, system 1 may (at action 427) perform analysis of wave dynamics and ensure the peak is “real” (action 427 may also be performed after or in association with action 426). FIGS. 5H-J show non-limiting example diagrams for performing such an analysis where different points are analyzed. In one example embodiment, system 1 may determine whether a peak(s) (e.g., peak 514) is a residual multiple from a back wall by analyzing different aspects of a signal. For example, system 1 may analyze a ratio of first points 511 associated with peaks of raw signal 501 and reference signal 502. Likewise system 1 may analyze a ratio of second points 512 associated with certain negative peaks of raw signal 501. System 1 may analyze third point 513 and determine if a “nearby” negative peak is beyond a threshold value (e.g., beyond 30% amplitude of an associated positive peak). This determination may be made in association with fourth point 514 which depicts a peak near a first backwall multiple.

If system (at action 416) provides a negative determination as to whether one or more peaks are close to backwalls or multiples, system 1 may (at action 426) find a nearest max amplitude negative dip and find a peak-to-peak amplitude. As discussed herein, FIGS. 5H-J depict such processing where the analysis of various points in the waveform data are analyzed. For example, system 1 may check whether a peak is a residual multiple from a first backwall multiple by analyzing the different aspects of the signal. In one example embodiment, system 1 may analyze a ratio of first points 515 associated with peaks of raw signal 501 and reference signal 502. Likewise, system 1 may analyze a ratio of second points 516 associated with certain negative peaks of raw signal 501. System 1 may analyze third point 517 and determine if a “nearby” negative peak is beyond a threshold value (e.g., beyond 30% amplitude of an associated positive peak). This determination may be made in association with fourth point 518 which depicts a peak near a second backwall multiple. As shown in FIG. 5J, system 1 may determine first points 519 associated with positive peaks away from back wall multiples. System 1 may also determine second points 520 associated with peak-to-peak amplitude measured with “nearest” negative peaks.

System 1 may (at actions 428 and 429) extract peaks near a first backwall multiple and extract peaks near a second backwall multiple. System 1 may (at action 430) determine whether a peak is a residual multiple from a back wall by comparing wave dynamics. If the determination is positive, system 1 may (at action 432) remove the peak from the list, and if the determination is negative, system 1 may (at action 433) retain the peak. Likewise, system 1 may (at action 431) determine whether a peak is a residual from a first backwall multiple by comparing wave dynamics. If the determination is positive, system 1 may (at action 432) remove the peak from the list, and if the determination is negative, system 1 may (at action 433) retain the peak.

FIG. 5K shows a non-limiting example diagram in association with determining whether a peak near a first backwall multiple is a residual multiple from the backwall. For example, system 1 may analyze first point 522 in association with a previous residual peak. System 1 may determine first point 522 indicating a positive peak near a first backwall multiple where adhesive curve 523 is “fitted” to pass through the positive peak for amplitude prediction. Second point 521 may not be within the analyzed limits and thus the positive peak 522 near a first back wall multiple is not an associated multiple.

FIG. 5L shows a non-limiting example diagram in association with determining whether a peak near a second backwall multiple is a multiple of an adhesive peak near the first backwall multiple. For example, system 1 may analyze first point 525 in association with a previous residual peak. System 1 may determine point 525 indicating a positive peak near a second backwall multiple where adhesive curve 523 is “fitted” to pass through the positive peak for amplitude prediction. Second point 524 may be within the analyzed limits and thus the positive peak 525 near a second back wall multiple is a multiple of the adhesive pulse.

System 1 may (at action 434) sort remaining selected peaks based on amplitude. System 1 may (at action 435) select a point with a highest amplitude. FIG. 5M shows a non-limiting example of adhesive peak(s) selected based on amplitude (e.g., peak-to-peak) and time of occurrence. For example, various peaks 526 may be “candidates” where selected peak 527 may be “picked” based on having a “highest” amplitude compared to the other peaks 526.

In conducting further analysis, system 1 may (at action 436) determine if the selected pick is a multiple of an adhesive. If the determination is positive, system 1 may “jump back” one multiple (at action 437). FIG. 5N shows a non-limiting example diagram for adhesive peak selection by “jumping back” one multiple. In the example shown in FIG. 5N, peak 528 is selected based on a highest amplitude, but when system 1 determines that peak 528 is an adhesive multiple, system 1 may select peak 529 (e.g., by looking for peaks earlier in time equal to first metal thickness ).

If the determination (at action 436) is negative, system 1 may check if the point is a second metal reflection based on a user second metal layer input thickness (at action 438). If the determination is positive, system 1 may “jump back” a second metal thickness (at action 439). FIG. 5O shows a non-limiting example diagram where an adhesive peak is selected by “jumping back” a second metal thickness. For example, a second metal reflection pulse 530 is shown in association with raw signal 501 where peak 531 is initially selected based on a highest amplitude. When system 1 determines that peak 531 is a second metal reflection, system 1 may select peak 532 (e.g., by looking for peaks earlier in time equal to second metal thickness). If the determination (at action 438) is negative, system 1 may (at action 440) display the first adhesive thickness. Such display and/or output are conveyed in a variety of manners, where certain output is shown with respect to FIGS. 6A and 6B.

After determining a first adhesive thickness, system 1 may perform actions to determine a second adhesive thickness. FIG. 5P shows a non-limiting example diagram where the second adhesive layer 50d is positioned between a second metal layer 50c and a third metal layer 50e. Similar to the process shown with respect to FIG. 5A, an object 50 may be scanned (e.g., using transducer 10) where different signals are obtained. In operating a transducer 10 on object 50, various signals may “bounce” internally 50a-e and between different layers of object 50 which for thin adhesives & adherends complicates thickness characterization. For example, one or more signals may traverse a first metal layer 50a, a first adhesive layer 50b, a second metal layer 50c, a second adhesive layer 50d, and/or a third metal layer 50e of object 50. For example, one signal may be indicative of a reflection from a second material. Another signal could be indicative of the second adhesive layer. Certain actions for determining a second adhesive layer thickness may be performed after determining and/or displaying the first adhesive layer thickness (i.e., at action 440).

In more detail, system 1 may (at action 441) determine if a user entered a second metal thickness greater than a specified value (e.g., 0.012”). If the determination is in the negative, the process may end and system 1 will not determine/display a second adhesive layer thickness. Otherwise, system 1 may (at action 442) determine if the first metal layer thickness is above a specified value (e.g., 0.020”) and determine if the first bondline is greater than a specified value (e.g., 0). If the determination is in the negative, the process may end and system 1 will not determine/display a second adhesive layer thickness. Otherwise, system 1 may (at action 443) determine if a first adhesive reflection is close to a backwall or if a second metal thickness is less than a specified value (e.g., 0.020”).

If the determination is in the positive, system 1 may (at action 444) “cut” a backwall multiple reflection pulse from a reference signal, invert the same and convert to unit pulse, and select this pulse as the adhesive template. Alternatively, if the determination is in the negative, system 1 may (at action 445) “cut” a true first adhesive pulse and convert the same to a unit pulse, where the pulse is selected as the adhesive template. An example pulse 533 selected as the adhesive template is shown in FIG. 5Q.

System 1 may (at action 446) re-sample the adhesive template based on a first metal thickness and a first adhesive thickness (e.g., to temporarily compress the pulse). System 1 may then (at action 447) find amplitudes and timings of all first adhesive reflection combinations, based on the first metal thickness, the first adhesive thickness, the second metal thickness and using attenuation, transmission factors, and phase change. Upon finding the amplitude(s) and timing(s), system 1 may (at action 448) construct an adhesive reflection signal using the unit adhesive template (and using the amplitude(s) and timing(s)).

After constructing the adhesive reflection signal, system 1 may (at action 449) subtract the reconstructed adhesive signal from a subtracted signal (e.g., subtracted signal 2). FIG. 5R shows a non-limiting example diagram where subtracted signal 2 (shown as element 534) may be determined. In the example shown in FIG. 5R, the reconstructed first adhesive thickness reflection signal, raw signal, subtracted signal, and subtracted signal 2 are displayed. The subtracted signal 2 may be determined by subtracting the reconstructed signal of the first adhesive thickness reflection(s) from the subtracted signal. In doing so, reflections from the first adhesive thickness are eliminated.

System 1 may (at action 450) find a second metal reflection on subtracted signal 2 (e.g., based on user input). An example showing the second metal index 535 is depicted in FIG. 5S where the raw signal and subtracted signal 2 are also displayed. System 1 may then (at action 451) find amplitudes and timings of all second metal reflection combinations, based on the first metal thickness, the first adhesive thickness, the second metal thickness and using attenuation, transmission factors, and phase change.

Using the amplitude(s) and timing(s), system 1 may (at action 452) construct a second metal reflection signal using the unit adhesive template. System 1 may (at action 453) subtract the reconstructed second metal signal from the subtracted signal 2 (e.g., to generate subtracted signal 3). FIG. 5T shows a non-limiting example diagram where subtracted signal 3 is determined and displayed. In particular, subtracted signal 3 (shown as element 536) is calculated by subtracting the reconstructed signal of the second metal thickness reflection from subtracted signal 2 (shown as element 535). In doing so, reflections from the second metal thickness are eliminated.

Upon calculating subtracted signal 3, system 1 may (at action 454) find a max peak of subtracted signal 3 occurring after the second metal peak, and then assume the same as the second adhesive thickness. System 1 may then (at action 455) determine if a second metal jump back is possible. If the determination is positive, system 1 may (at action 456) jump back the second metal thickness and find a max peak of a pulse in the area. System 1 may also check the ratio of amplitude with respect to the second metal peak to determine if it is greater than a threshold calculated by equation. The equation may include equation(s) to predict the second adhesive amplitude versus thickness (shown as action 457). FIG. 5U shows a non-limiting example diagram where the true second adhesive peak is selected by jumping back the second metal thickness. In particular, peak 537 is selected based on a highest amplitude where peak 538 is then determined by jumping back the value.

If the determination at action 456 is positive, system 1 may (at action 458) convert the pulse to unit pulse and find the correlation coefficient with respect to the adhesive template. System 1 may (at action 459) determine if the value is a multiple and if so, system 1 may (at action 460) jump back one multiple thickness and find the max peak of the pulse. System 1 may further determine if the ratio of amplitude with respect to the second metal peak is greater than a threshold calculated by equation. In one example embodiment, the equation may correspond to an equation to predict the second adhesive amplitude versus thickness (at action 461).

If the determination at action 460 is positive, system 1 may (at action 462) convert the pulse to a unit pulse and find a correlation coefficient with respect to the adhesive template. System 1 may proceed (at action 463) to determine if a first adhesive jump back is possible. Likewise, if any of the determinations with respect to actions 455, 456, 459, and/or 460 are negative, system 1 may determine (at action 463) if a first adhesive jump back is possible.

If a first adhesive jump back is possible, system 1 may (at action 464) jump back the first adhesive thickness and find a max peak of a pulse. System 1 may further determine if a ratio of amplitude with respect to the second metal peak is greater than a threshold calculated by equation. In one example embodiment, the equation may correspond to an equation to predict the second adhesive amplitude versus thickness (at action 465).

System 1 may (at action 466) convert the pulse to a unit pulse and find the correlation coefficient with respect to the adhesive template. System 1 may (at action 467) determine if the value is a multiple and if the determination is positive, system 1 may (at action 468) jump back one multiple thickness and find the max peak of the pulse. System 1 may further determine if the ratio of the amplitude with respect to the second metal peak is greater than a threshold calculated by equation. In one example embodiment, the equation may correspond to the equation to predict the second adhesive amplitude versus thickness (at action 469).

If the determination at action 468 is positive, system 1 may (at action 470) convert the pulse to a unit pulse and find the correlation coefficient with respect to the adhesive template. System 1 may then determine if the value is a multiple. Likewise, if any of the determinations with respect to actions 463, 464, 467, and/or 468 are negative, system 1 may (at action 471) determine if the value is a multiple.

If the determination at action 471 is positive, system 1 may (at action 472) jump back one multiple thickness and find the max peak of the pulse. System 1 may further determine if the ratio of amplitude with respect to the second metal peak is greater than a threshold calculated by equation. In one example embodiment, the equation may correspond to the equation to predict the second adhesive amplitude versus thickness (at action 473).

If the determination at action 472 is positive, system 1 may (at action 474) convert the pulse to a unit pulse and find the correlation coefficient with respect to the adhesive template. System 1 may (at action 475) check if a first metal thickness jump back is possible. Likewise, if any of the determinations with respect to actions 471 and/or 472 are negative, system 1 may (at action 475) check if a first metal thickness jump back is possible.

If the first metal thickness jump back is possible, system 1 may (at action 476) jump back the first adhesive thickness and find a max peak of the pulse. System 1 may further determine if the ratio of the amplitude with respect to the second metal peak is greater than a threshold calculated by equation. In one example embodiment, the equation may correspond to the equation to predict the second adhesive amplitude versus thickness (at action 477).

If the determination at action 476 is positive, system 1 may (at action 478) convert the pulse to a unit pulse and find the correlation coefficient with respect to the adhesive template. System 1 may (at action 479) determine if the value is a multiple and, if so, system 1 may (at action 480) jump back one multiple thickness and find the max peak of the pulse. System 1 may further determine if the ratio of amplitude with respect to the second metal peak is greater than a threshold calculated by equation. In one example embodiment, the equation may correspond to the equation to predict the second adhesive amplitude versus thickness (at action 481).

If the determination at action 480 is positive, system 1 may (at action 482) convert the pulse to a unit pulse and find the correlation coefficient with respect to the adhesive template. From all of the aforementioned selected pulses, system 1 may (at action 483) select a pulse with a correlation coefficient greater than a specified value (e.g., 0.8). Likewise, if any of the determinations with respect to actions 475, 476, and/or 479 are negative, system 1 may (at action 483) select the pulse with the correlation coefficient greater than the specified value.

System 1 may (at action 484) select the pulse with the highest amplitude. An example of the true second adhesive peak selection is shown in FIG. 5V. In one example embodiment, the second adhesive reflection 539 is determined in association with the pulse amplitude and correlation coefficient. For example, the true second adhesive peak is selected based on the pulse amplitude and correlation coefficient with respect to the adhesive template. System 1 may then (at action 485) display the second adhesive thickness. Such display and/or output are conveyed in a variety of manners, where certain output is shown with respect to FIGS. 6A and 6B.

In particular, FIGS. 6A and 6B show various output generated in association with system 1. For example, FIG. 6A shows an example user interface 600 generated in association with processing performed by system 1. FIG. 6B shows a non-limiting example output 650 produced by system 1 in association with various processing.

FIG. 6A shows an example user interface 600 having different portions containing output data for processing in system 1, while also having different portions for operating interface 600. For example, user interface 600 can include metal thickness portion 601 providing values associated with measuring the metal thickness of different metal layers. In the example shown in FIG. 6, a first metal layer has been measured and thus the thickness value for “Metal 1” indicates a value of 0.032 inches. As system 1 continues processing, thickness values for other metal layers may be measured, and thus values for “Metal 2” and “Metal 3” may change from “0.0” to a specific thickness measurement value.

User interface 600 can also include a bondline thickness portion 602 providing values associated with measuring thickness of different bondlines (e.g., adhesive layers). In the example shown in FIG. 6, a first bondline has been measured and thus the thickness value for “1^{st} Bondline” indicates a value of 0.004 inches. As system 1 continues processing, thickness values for other bondline layers may be measured, and thus values for “2^{nd} Bondline” may change from “N/A” to a specific thickness measurement value.

A user may be able to operate various portions of user interface 600 to generate additional output. For example, panel portion 603 includes various “button” items that allow a user to generate other output (or views of the user interface 600). For example, a user can select “Result Table” which may generate measurement table 610, as shown in the output 650 of FIG. 6B for data recording. That is, measurement table 610 may include different columns having values associated with measuring the thickness values, and different rows associated with each measurement task. These examples are of course non-limiting, and selection of other items in panel portion 603 may produce other different output. For example, selection of “Open Drawing” may result in another output showing import part drawings and/or measurement locations.

User interface 600 may also include a setup element 604 associated with configuring certain aspects of the system 1. For example, selection of setup element 604 may allow a user to configure various aspects associated with input processing (e.g., of transducer 10) as well as various aspects associated with operating and performing execution of the measurement algorithm. These examples are of course non-limiting and selection of setup element 604 can enable configuration of any other aspect of system 1.

User interface 600 may also include a reference element 605 for performing measurement associated with acquiring a reference signal. For example, a user may operate transducer 10 to measure portions of reference object 60 (as shown in FIG. 1) and then select reference element 605 to begin acquiring a reference signal. Likewise, user interface can include a measure element 606 for performing measurement associated with other acquired signals. That is, selection of measure element 606 may be performed as user operates transducer 10 in measuring portions of object 50. Upon selecting measure element 606, different values in portions 602 and 603 may change as the system 1 performs various processing. It should be appreciated that the items shown in FIGS. 6A and 6B are of course non-limiting and the system 1 can produce any type of output and/or user interface in association with performing the various measurement tests described herein.

FIG. 7 shows a non-limiting example block diagram of a hardware architecture for the system. In the example shown in FIG. 7, the client device 1210 communicates with a server system 1250 via a network 1240. The network 1240 could comprise a network of interconnected computing devices, such as the internet. The network 1240 could also comprise a local area network (LAN) or could comprise a peer-to-peer connection between the client device 1210 and the server system 1250. The hardware elements shown could be used to implement various software components and actions shown and described above as being included in and/or executed at the client device 1210 and/or server system 1250.

In some embodiments, the client device 1210 (which may also be referred to as “client system” herein) includes one or more of the following: one or more processors 1212; one or more memory devices 1214; one or more network interface devices 1216; one or more display interfaces 1218; and one or more user input adapters 1220. Additionally, in some embodiments, the client device 1210 is connected to or includes a display device 1230. As will explained below, these elements (e.g., the processors 1212, memory devices 1214, network interface devices 1216, display interfaces 1218, user input adapters 1220, display device 1230) are hardware devices (for example, electronic circuits or combinations of circuits) that are configured to perform various different functions for the computing device 1210.

In some embodiments, each or any of the processors 1212 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1212 uses an instruction set architecture such as x86 or Advanced RISC Machine (ARM).

In some embodiments, each or any of the memory devices 1214 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1212). Memory devices 1214 are examples of non-volatile computer-readable storage media.

In some embodiments, each or any of the network interface devices 1216 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 1218 is or includes one or more circuits that receive data from the processors 1212, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1230, which displays the image data. Alternatively or additionally, in some embodiments, each or any of the display interfaces 1218 is or includes, for example, a video card, video adapter, or graphics processing unit (GPU).

In some embodiments, each or any of the user input adapters 1220 is or includes one or more circuits that receive and process user input data from one or more user input devices (not shown) that are included in, attached to, or otherwise in communication with the client device 1210, and that output data based on the received input data to the processors 1212. Alternatively or additionally, in some embodiments each or any of the user input adapters 1220 is or includes, for example, a PS/2 interface, a USB interface, a touchscreen controller, or the like; and/or the user input adapters 1220 facilitates input from user input devices (not shown) such as, for example, a keyboard, mouse, trackpad, touchscreen, etc...

In some embodiments, the display device 1230 may be a Liquid Crystal Display (LCD) display, Light Emitting Diode (LED) display, or other type of display device. In embodiments where the display device 1230 is a component of the client device 1210 (e.g., the computing device and the display device are included in a unified housing), the display device 1230 may be a touchscreen display or non-touchscreen display. In embodiments where the display device 1230 is connected to the client device 1210 (e.g., is external to the client device 1210 and communicates with the client device 1210 via a wire and/or via wireless communication technology), the display device 1230 is, for example, an external monitor, projector, television, display screen, etc...

In various embodiments, the client device 1210 includes one, or two, or three, four, or more of each or any of the above-mentioned elements (e.g., the processors 1212, memory devices 1214, network interface devices 1216, display interfaces 1218, and user input adapters 1220). Alternatively or additionally, in some embodiments, the client device 1210 includes one or more of: a processing system that includes the processors 1212; a memory or storage system that includes the memory devices 1214; and a network interface system that includes the network interface devices 1216.

The client device 1210 may be arranged, in various embodiments, in many different ways. As just one example, the client device 1210 may be arranged such that the processors 1212 include: a multi (or single)-core processor; a first network interface device (which implements, for example, WiFi, Bluetooth, NFC, etc…); a second network interface device that implements one or more cellular communication technologies (e.g., 3G, 4G LTE, CDMA, etc…); memory or storage devices (e.g., RAM, flash memory, or a hard disk). The processor, the first network interface device, the second network interface device, and the memory devices may be integrated as part of the same SOC (e.g., one integrated circuit chip). As another example, the client device 1210 may be arranged such that: the processors 1212 include two, three, four, five, or more multi-core processors; the network interface devices 1216 include a first network interface device that implements Ethernet and a second network interface device that implements WiFi and/or Bluetooth; and the memory devices 1214 include a RAM and a flash memory or hard disk.

Server system 1250 also comprises various hardware components used to implement the software elements. In some embodiments, the server system 1250 (which may also be referred to as “server device” herein) includes one or more of the following: one or more processors 1252; one or more memory devices 1254; and one or more network interface devices 1256. As will explained below, these elements (e.g., the processors 1252, memory devices 1254, network interface devices 1256) are hardware devices (for example, electronic circuits or combinations of circuits) that are configured to perform various different functions for the server system 1250.

In some embodiments, each or any of the processors 1252 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1252 uses an instruction set architecture such as x86 or Advanced RISC Machine (ARM).

In some embodiments, each or any of the memory devices 1254 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1252). Memory devices 1254 are examples of non-volatile computer-readable storage media.

In some embodiments, each or any of the network interface devices 1256 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In various embodiments, the server system 1250 includes one, or two, or three, four, or more of each or any of the above-mentioned elements (e.g., the processors 1252, memory devices 1254, network interface devices 1256). Alternatively or additionally, in some embodiments, the server system 1250 includes one or more of: a processing system that includes the processors 1252; a memory or storage system that includes the memory devices 1254; and a network interface system that includes the network interface devices 1256.

The server system 1250 may be arranged, in various embodiments, in many different ways. As just one example, the server system 1250 may be arranged such that the processors 1252 include: a multi (or single)-core processor; a first network interface device (which implements, for example, WiFi, Bluetooth, NFC, etc…); a second network interface device that implements one or more cellular communication technologies (e.g., 3G, 4G LTE, CDMA, etc…); memory or storage devices (e.g., RAM, flash memory, or a hard disk). The processor, the first network interface device, the second network interface device, and the memory devices may be integrated as part of the same SOC (e.g., one integrated circuit chip). As another example, the server system 1250 may be arranged such that: the processors 1252 include two, three, four, five, or more multi-core processors; the network interface devices 1256 include a first network interface device that implements Ethernet and a second network interface device that implements WiFi and/or Bluetooth; and the memory devices 1254 include a RAM and a flash memory or hard disk.

As previously noted, whenever it is described in this document that a software module or software process performs any action, the action is in actuality performed by underlying hardware elements according to the instructions that comprise the software module. In such embodiments, the following applies for each software module: (a) the elements of the client device 1210 (i.e., the one or more processors 1212, one or more memory devices 1214, one or more network interface devices 1216, one or more display interfaces 1218, and one or more user input adapters 1220) and the elements of the server system 1250 (i.e., the one or more processors 1252, one or more memory devices 1254, one or more network interface devices 1256), or appropriate combinations or subsets of the foregoing, are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the respective memory devices (e.g., in various embodiments, in a volatile memory device such as a RAM or an instruction register and/or in a non-volatile memory device such as a flash memory or hard disk) and all actions described herein as performed by the software modules are performed by the respective processors in conjunction with, as appropriate, the other elements in and/or connected to the client device 1210 or server system 1250; (c) alternatively or additionally, to the extent it is described herein that the component processes and/or otherwise handles data, in some embodiments, such data is stored in the respective memory devices (e.g., in some embodiments, in a volatile memory device such as a RAM and/or in a non-volatile memory device such as a flash memory or hard disk) and/or is processed/handled by the respective processors in conjunction, as appropriate, the other elements in and/or connected to the client device 1210 or server system 1250; (d) alternatively or additionally, in some embodiments, the respective memory devices store instructions that, when executed by the respective processors, cause the processors to perform, in conjunction with, as appropriate, the other elements in and/or connected to the client device 1210 or server system 1250, each or any combination of actions described herein as performed by the component and/or by any software modules described herein as included within the component.

The hardware configurations shown in the figure and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above, (e) via other hardware arrangements, architectures, and configurations, and/or via combinations of the technology described in (a) through (e).

### Technical Advantages of Described Subject Matter

The technology described herein provides a system for measuring thickness in various structure. More specifically, the technology describes an improved system for testing metal adhesive bondline thickness and measuring thickness of various layers (e.g., metal, adhesive). The technology also describes an improved user interface that conveys various information associated with measuring the thickness in the various structure thus improving the overall human-computer interface. The technology advantageously allows the system to accurately measure thickness in different layers of the structure thereby improving design and manufacturing associated with the measured object. For example, the technology advantageously measures various bondline thickness in order to improve the design and manufacture of various aircraft components.

### Further Applications of Described Subject Matter

As used in this document, the term "non-transitory computer-readable storage medium" includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage.

As used in this document, the term “and/or” includes any and all combinations of one or more of the associated listed items.

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms "a", "an" and "the" should be read as meaning “at least one,” “one or more,” or the like; the term “example” is used provide examples of the subject under discussion, not an exhaustive or limiting list thereof; the terms "comprise” and “include” (and other conjugations and other variations thereof) specify the presence of the associated listed items but do not preclude the presence or addition of one or more other items; and if an item is described as “optional,” such description should not be understood to indicate that other items are also not optional.

Although process steps, algorithms or the like, including without limitation with reference to any of the figures, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed.

While the technology has been described in connection with what is presently considered to be an illustrative practical and preferred embodiment, it is to be understood that the technology is not to be limited to the disclosed embodiment, but on the contrary, is intended to cover various modifications and equivalent arrangements.

1. A system, comprising:
a processor; and
a memory configured to store computer readable instructions that, when executed by the processor, cause the system to:
obtain a reference signal using an ultrasonic transducer;
obtain a first signal using the ultrasonic transducer;
measure a first metal thickness for a first metal layer based on the obtained first signal;
determine the reference signal based on the measured first metal thickness;
subtract the reference signal from the first signal;
using waveform data from the first signal, analyze a plurality of elements in the waveform data;
determine a first adhesive thickness for a first adhesive layer based on analyzing the plurality of elements in the waveform data; and
generate, for display, user interface data for generating a user interface.

2. The system of claim 1, wherein analyzing the plurality of elements in the waveform data includes analyzing a plurality of peaks from waveforms in the waveform data and determining the first adhesive thickness for the first adhesive layer based on analyzing the plurality of peaks from the waveforms.

3. The system of claim 1, wherein the system is further caused to:
perform an iterative process of analyzing and removing peaks from the waveform data; and
determine the first adhesive thickness for the first adhesive layer based on performing the iterative process.

4. The system of claim 1, wherein the system is further caused to:
determine a first algorithm for selecting an adhesive reflection;
analyze the waveform data to final all positive peaks; and
generate a list of possible adhesive reflections based on the analysis.

5. The system of claim 4, wherein the system is further caused to:
predict an adhesive curve using a first formula; and
determine positive peaks from the waveform data having values greater than an adhesive curve threshold.

6. The system of claim 5, wherein the system is further caused to:
filter positive peaks from the waveform data using an iterative process; and
determine the first adhesive thickness for the first adhesive layer after performing the iterative process.

7. The system of claim 1, wherein the system is further caused to:
determine a second metal thickness for a second metal layer based on analyzing the plurality of elements in the waveform data; and
determine a second adhesive thickness for a second adhesive layer based on analyzing the plurality of elements in the waveform data.

8. The system of claim 1, wherein the user interface includes a first display having a first portion showing values associated with the first metal thickness, and a second portion showing values associated with the first adhesive thickness.

9. The system of claim 1, wherein the first metal thickness and/or the first adhesive thickness are used in association with building an aircraft.

10. A method for determining thickness of layers in bonded metal, the method comprising:
obtaining a first signal using a transducer;
measuring a first metal thickness for a first metal layer based on the obtained first signal;
determining a reference signal based on the measured first metal thickness;
subtracting the reference signal from the first signal;
using waveform data from the first signal, analyzing a plurality of elements in the waveform data;
determining a first adhesive thickness for a first adhesive layer based on analyzing the plurality of elements in the waveform data; and
generating, for display, user interface data for generating a user interface.

11. The method of claim 10, further comprising obtaining the reference signal using the transducer.

12. The method of claim 10, wherein analyzing the plurality of elements in the waveform data includes analyzing a plurality of peaks from waveforms in the waveform data and determining the first adhesive thickness for the first adhesive layer based on analyzing the plurality of peaks from the waveforms.

13. The method of claim 10, further comprising:
performing an iterative process of analyzing and removing peaks from the waveform data; and
determining the first adhesive thickness for the first adhesive layer based on performing the iterative process.

14. The method of claim 10, further comprising:
determining a second metal thickness for a second metal layer based on analyzing the plurality of elements in the waveform data; and
determining a second adhesive thickness for a second adhesive layer based on analyzing the plurality of elements in the waveform data.

15. The method of claim 10, wherein the user interface includes a first display having a first portion showing values associated with the first metal thickness, and a second portion showing values associated with the first adhesive thickness.

16. A non-transitory computer readable storage medium storing computer readable instructions that, when executed by a processor of an information processing apparatus, cause the processor to provide execution comprising:
obtaining a first signal using a transducer;
measuring a first metal thickness for a first metal layer based on the obtained first signal;
using waveform data from the first signal, analyzing a plurality of elements in the waveform data; and
determining a first adhesive thickness for a first adhesive layer based on analyzing the plurality of elements in the waveform data.

17. The non-transitory computer readable storage medium of claim 16, wherein the processor is further caused to provide execution comprising:
obtaining the reference signal using the transducer;
determining a reference signal based on the measured first metal thickness; and
subtracting the reference signal from the first signal.

18. The non-transitory computer readable storage medium of claim 16, wherein the processor is further caused to provide execution comprising generating, for display, user interface data for generating a user interface.

19. The non-transitory computer readable storage medium of claim 16, wherein the processor is further caused to provide execution comprising:
performing an iterative process of analyzing and removing peaks from the waveform data; and
determining the first adhesive thickness for the first adhesive layer based on performing the iterative process.

20. The non-transitory computer readable storage medium of claim 16, wherein the processor is further caused to provide execution comprising:
determining a second metal thickness for a second metal layer based on analyzing the plurality of elements in the waveform data; and
determining a second adhesive thickness for a second adhesive layer based on analyzing the plurality of elements in the waveform data.
